(19) United States
(12) Patent Application Publication
(10) Pub. No.: US 2024/0091906 A1
(43) Pub. Date: Mar. 21, 2024

(54) SYSTEMS AND METHODS FOR MODIFYING SURFACES OF ADDITIVELY MANUFACTURED OBJECTS

(71) Applicant: Align Technology, Inc., San Jose, CA (US)

(72) Inventors: Paramjot Singh, San Jose, CA (US); Lance Robert Pickens, Campbell, CA (US); Chunhua Li, Cupertino, CA (US)

(21) Appl. No.: 18/467,584

(22) Filed: Sep. 14, 2023

Related U.S. Application Data
(60) Provisional application No. 63/375,738, filed on Sep. 15, 2022.

(51) Int. Cl. B24C 3/28; B24C 7/00; B33Y 40/20

(52) U.S. Cl. CPC B24C 3/28; B24C 7/0046; B33Y 40/20

(57) ABSTRACT

Systems and methods for processing additively manufactured objects are described herein. In some embodiments, for example, a system includes a controller configured to provide one or more control signals; a heater coupled to the controller, where the heater comprises one or more heating elements arranged to heat a blasting medium in response to the one or more control signals; a chamber coupled to the controller, where the chamber comprises an agitatable drum shaped to receive a plurality of additively manufactured objects, and to agitate the plurality of additively manufactured objects in response to the one or more control signals; and an applicator coupled to the controller, where the applicator comprises a nozzle operative to direct, in response to the one or more control signals, a plurality of thermally conductive particles in the blasting medium toward the plurality of additively manufactured objects within the agitatable drum.

### CROSS-REFERENCE TO RELATED APPLICATION(S)

The present application claims the benefit of priority to U.S. Provisional Patent Application No. 63/375,738, filed Sep. 15, 2022, which is incorporated by reference herein its entirety.

### TECHNICAL FIELD

The present technology generally relates to manufacturing processes, and in particular, to methods for modifying the surfaces of additively manufactured objects.

### BACKGROUND

Additive manufacturing encompasses a variety of technologies that involve building up 3D objects from multiple layers of material. The surface characteristics of objects fabricated using conventional additive manufacturing techniques may be unsatisfactory for certain applications. For example, additively manufactured objects may exhibit excessive surface roughness and porosity, which can lead to staining, odor issues, fluid infiltration, and microbial contamination when exposed to physiological environments such as the patient's intraoral cavity. Conventional chemical-based surface finishing processes may be impractical for large scale production of additively manufactured objects due to the use of costly, single-use reagents. Chemical processing may also compromise the mechanical properties of the object and/or may leave residual material within the object that poses safety risks for patient use.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a flow diagram of a method for fabricating and post-processing an additively manufactured object, in accordance with embodiments of the present technology.

FIG. 2 is a partially schematic diagram of a system for additive manufacturing, in accordance with embodiments of the present technology.

FIG. 3 is a schematic diagram of a system for fabricating and processing additively manufactured objects, in accordance with embodiments of the present technology.

FIG. 4 is a flow diagram illustrating a method for processing an additively manufactured object, in accordance with embodiments of the present technology.

FIG. 5A is a partially schematic diagram of a system for processing one or more additively manufactured objects, in accordance with embodiments of the present technology.

FIG. 5B is a partially schematic diagram of a receptacle for processing one or more additively manufactured objects, in accordance with embodiments of the present technology.

FIG. 6 is a flow diagram illustrating another method for processing an additively manufactured object, in accordance with embodiments of the present technology.

FIG. 7A is a partially schematic diagram of a system for processing an additively manufactured object, in accordance with embodiments of the present technology.

FIG. 7B is a partially schematic diagram of another system for processing an additively manufactured object, in accordance with embodiments of the present technology.

FIG. 8A is a perspective view of a palatal expander configured in accordance with embodiments of the present technology.

FIG. 8B illustrates surface modification of the palatal expander using a heating element, in accordance with embodiments of the present technology.

FIG. 8C illustrates surface modification of the palatal expander using a movable heating element, in accordance with embodiments of the present technology.

FIG. 9A illustrates a representative example of a tooth repositioning appliance configured in accordance with embodiments of the present technology.

FIG. 9B illustrates a tooth repositioning system including a plurality of appliances, in accordance with embodiments of the present technology.

FIG. 9C illustrates a method of orthodontic treatment using a plurality of appliances, in accordance with embodiments of the present technology.

FIG. 10 illustrates a method for designing an orthodontic appliance, in accordance with embodiments of the present technology.

FIG. 11 illustrates a method for digitally planning an orthodontic treatment and/or design or fabrication of an appliance, in accordance with embodiments of the present technology.

### DETAILED DESCRIPTION

The present technology relates to methods for processing additively manufactured objects. In some embodiments, for example, a method involves receiving an object fabricated using an additive manufacturing process. The method can include modifying a surface of the object by applying a blasting medium (e.g., a plurality of thermally conductive particles) to the surface of the object. The blasting medium can be heated to an elevated temperature to facilitate mechanical deformation of the object surface. For example, the mechanical deformation can reduce the roughness and/or porosity of the object surface. The method can optionally include collecting the blasting medium for reuse.

As another example, a method can involve obtaining topography data (e.g., height data) of a surface of an object fabricated using an additive manufacturing process. The method can further include modifying the surface of the object by applying heat to the surface of the object, based on the topography data. For instance, the applied heat can at least partially melt the surface of the object in order to reduce roughness and/or porosity. In some embodiments, the heat is applied by at least one flame generator, and the positioning (e.g., vertical position) and/or flame characteristics (e.g., flame size and/or intensity) of the flame generator can be customized according to the particular surface topography of the object.

The present technology can provide many advantages over conventional surface finishing processes, such as low cost, scalability for mass production, utilizing reusable materials, avoiding the use of toxic reagents, and/or maintaining the mechanical integrity of the final product. In some embodiments, the techniques described herein are used to improve the surface characteristics of additively manufactured dental appliances (e.g., palatal expanders), which can be beneficial for enhancing the appearance of the appliance, reducing staining and odors, and/or reducing infiltration of fluids, microorganisms, and/or other contaminants.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “horizontal,” “lateral,” “upper,” and “lower” can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Overview of Additive Manufacturing Technology

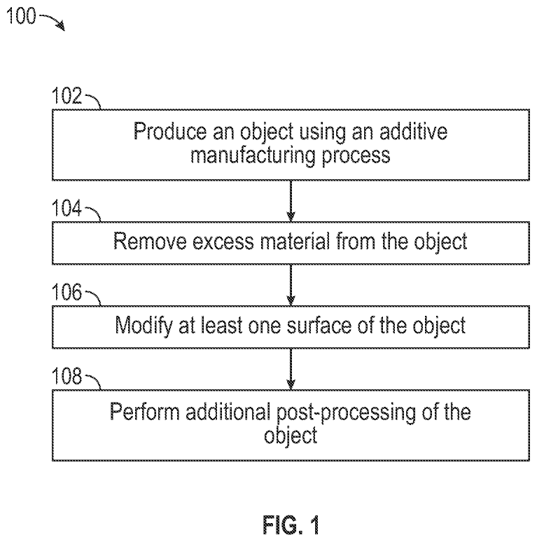

FIG. 1 is a flow diagram providing a general overview of a method 100 for fabricating and post-processing an additively manufactured object, in accordance with embodiments of the present technology. The method 100 can be used to produce many different types of additively manufactured objects, such as orthodontic appliances (e.g., aligners, palatal expanders, retainers, attachments, attachment placement devices), restorative objects (e.g., crowns, veneers, implants), and/or other dental devices (e.g., oral sleep apnea appliances, mouth guards).

The method 100 begins at block 102 with producing an object using an additive manufacturing process. The additive manufacturing process can implement any suitable technique known to those of skill in the art. Additive manufacturing (also referred to herein as “3D printing”) includes a variety of technologies which fabricate 3D objects directly from digital models through an additive process. In some embodiments, additive manufacturing includes depositing a precursor material onto a build platform. The precursor material can be cured, polymerized, melted, sintered, fused, and/or otherwise solidified to form a portion of the object and/or to combine the portion with previously formed portions of the object. In some embodiments, the additive manufacturing techniques provided herein build up the object geometry in a layer-by-layer fashion, with successive layers being formed in discrete build steps. Alternatively or in combination, the additive manufacturing techniques described herein can allow for continuous build-up of an object geometry.

Examples of additive manufacturing techniques suitable for use with the methods described herein include, but are not limited to, the following: (1) vat photopolymerization, in which an object is constructed from a vat of liquid photopolymer resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, an additive manufacturing process can use a combination of two or more additive manufacturing techniques.

For example, the additively manufactured object can be fabricated using a vat photopolymerization process in which light is used to selectively cure a vat or reservoir of a curable material (e.g., a polymeric resin). Each layer of curable material can be selectively exposed to light in a single exposure (e.g., DLP) or by scanning a beam of light across the layer (e.g., SLA). Vat polymerization can be performed in a “top-down” or “bottom-up” approach, depending on the relative locations of the vat, light source, and build platform.

As another example, the additively manufactured object can be fabricated using high temperature lithography (also known as “hot lithography”). High temperature lithography can include any photopolymerization process that involves heating a photopolymerizable material (e.g., a polymeric resin). For example, high temperature lithography can involve heating the material to a temperature of at least 30° C., 40° C., 50° C., 60° C., 70° C., 80° C., 90° C., 100° C., 110° C., or 120° C. In some embodiments, the material is heated to a temperature within a range from 50° C. to 120° C., from 90° C. to 120° C., from 100° C. to 120° C., from 105° C. to 115° C., or from 105° C. to 110° C. The heating can lower the viscosity of the photopolymerizable material before and/or during curing, and/or increase reactivity of the photopolymerizable material. Accordingly, high temperature lithography can be used to fabricate objects from highly viscous and/or poorly flowable materials, which, when cured, may exhibit improved mechanical properties (e.g., stiffness, strength, stability) compared to other types of materials. For example, high temperature lithography can be used to fabricate objects from a material having a viscosity of at least 5 Pa-s, 10 Pa-s, 15 Pa-s, 20 Pa-s, 30 Pa-s, 40 Pa-s, or 50 Pa-s at 20° C. Representative examples of high-temperature lithography processes that may be incorporated in the methods herein are described in International Publication Nos. WO 2015/075094, WO 2016/078838, WO 2018/032022, WO 2020/070639, WO 2021/130657, and WO 2021/130661, the disclosures of each of which are incorporated herein by reference in their entirety.

In some embodiments, the additively manufactured object is fabricated using continuous liquid interphase production (also known as “continuous liquid interphase printing”) in which the object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Representative examples of continuous liquid interphase production processes that may be incorporated in the methods herein are described in U.S. Patent Publication Nos. 2015/0097315, 2015/0097316, and 2015/0102532, the disclosures of each of which are incorporated herein by reference in their entirety.

As another example, a continuous additive manufacturing method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety. In another example, a continuous additive manufacturing method can involve extruding a composite material composed of a curable liquid material surrounding a solid strand. The composite material can be extruded along a continuous three-dimensional path in order to form the object. Such methods are described in U.S. Pat. No. 10,162,264 and U.S. Patent Publication No. 2014/0061974, the disclosures of which are incorporated herein by reference in their entirety. In yet another example, a continuous additive manufacturing method can utilize a “heliolithography” approach in which the liquid photopolymer is cured with focused radiation while the build platform is continuously rotated and raised. Accordingly, the object geometry can be continuously built up along a spiral build path. Such methods are described in U.S. Patent Publication No. 2014/0265034, the disclosure of which is incorporated herein by reference in its entirety.

In a further example, the additively manufactured object can be fabricated using a volumetric additive manufacturing (VAM) process in which an entire object is produced from a 3D volume of resin in a single print step, without requiring layer-by-layer build up. During a VAM process, the entire build volume is irradiated with energy, but the projection patterns are configured such that only certain voxels will accumulate a sufficient energy dosage to be cured. Representative examples of VAM processes that may be incorporated into the present technology include tomographic volumetric printing, holographic volumetric printing, multiphoton volumetric printing, and xolography. For instance, a tomographic VAM process can be performed by projecting 2D optical patterns into a rotating volume of photosensitive material at perpendicular and/or angular incidences to produce a cured 3D structure. A holographic VAM process can be performed by projecting holographic light patterns into a stationary reservoir of photosensitive material. A xolography process can use photoswitchable photoinitiators to induce local polymerization inside a volume of photosensitive material upon linear excitation by intersecting light beams of different wavelengths. Additional details of VAM processes suitable for use with the present technology are described in U.S. Pat. No. 11,370,173, U.S. Patent Publication No. 2021/0146619, U.S. Patent Publication No. 2022/0227051, International Publication No. WO 2017/115076, International Publication No. WO 2020/245456, International Publication No. WO 2022/011456, and U.S. Provisional Patent Application No. 63/181,645, the disclosures of each of which are incorporated herein by reference in their entirety.

In yet another example, the additively manufactured object can be fabricated using a powder bed fusion process (e.g., SLS) involving using a laser beam to selectively fuse a layer of powdered material according to a desired cross-sectional shape in order to build up the object geometry. As another example, the additively manufactured object can be fabricated using a material extrusion process (e.g., fused deposition modeling) involving selectively depositing a thin filament of material (e.g., thermoplastic polymer) in a layer-by-layer manner in order to form an object. In yet another example, the additively manufactured object can be fabricated using a material jetting process involving jetting or extruding one or more materials onto a build surface in order to form successive layers of the object geometry.

The additively manufactured object can be made of any suitable material or combination of materials. In some embodiments, the additively manufactured object is formed from a single type of material, such that the entire object has the same chemical composition. Alternatively, the additively manufactured object can be fabricated from a plurality of different material types (e.g., at least two, three, four, five, or more different material types), such that different portions of the object can have different chemical compositions. The material types can differ from each other with respect to composition, curing conditions (e.g., curing energy wavelength), material properties before curing (e.g., viscosity), material properties after cured (e.g., stiffness, strength, transparency), and so on. In some embodiments, the additively manufactured object is formed from multiple materials in a single manufacturing step. For instance, a multi-tip extrusion apparatus can be used to selectively dispense multiple types of materials from distinct material supply sources in order to fabricate an object from a plurality of different materials. Examples of such methods are described in U.S. Pat. Nos. 6,749,414 and 11,318,667, the disclosures of which are incorporated herein by reference in their entirety. Alternatively or in combination, the additively manufactured object can be formed from multiple materials in a plurality of sequential manufacturing steps. For instance, a first portion of the object can be formed from a first material in accordance with any of the methods herein, then a second portion of the object can be formed from a second material in accordance with methods herein, and so on, until the entirety of the object has been formed.

After the additively manufactured object is fabricated, the object can undergo one or more additional process steps, also referred to herein as “post-processing.” As described in detail below with respect to blocks 104-108, post-processing can include removing excess material from the object, modifying the object surface, and/or performing additional operations.

For example, at block 104, the method 100 continues with removing excess material from the additively manufactured object. The excess material can include unincorporated precursor material (e.g., unsintered powder) and/or other unwanted material (e.g., debris) that remains on or within the object after the additive manufacturing process. The excess material can be removed in many different ways, such as by exposing the object to a solvent (e.g., via spraying, immersion), heating or cooling the object, applying a vacuum to the object, blowing a pressurized gas onto the object, applying mechanical forces to the object (e.g., vibration, agitation, centrifugation, tumbling, brushing), and/or other suitable techniques. Optionally, the excess material can be collected and/or processed for reuse.

At block 106, the method 100 can include modifying at least one surface of the object. The surface modifications can be applied to some or all of the surfaces of the object (e.g., the exterior and/or interior surfaces) to alter one or more surface characteristics, such as the surface finish (e.g., roughness, waviness, lay), porosity, visual appearance (e.g., gloss, transparency, visibility of print lines), hydrophobicity, and/or chemical reactivity. In some embodiments, the surface processing is configured to reduce or eliminate undesirable surface characteristics that may be present in the object after the additive manufacturing process. For example, objects fabricated using certain types of additive manufacturing processes (e.g., SLS) may exhibit a relatively high degree of surface roughness, which can lead to issues such as staining, odors, unappealing visual appearance, and/or patient discomfort when worn. Surface roughness can be quantified in various ways, such as using the average roughness (Ra) (corresponding to the deviation of a surface from the arithmetic mean height of the surface), and can be measured in accordance with techniques known to those of skill in the art, including contact methods (e.g., stylus profilometry) and non-contact methods (e.g., interferometry, microscopy, focus variation, confocal chromatic aberration). In some embodiments, the object has an initial Ra of at least 5 μm, 10 μm, 15 μm, or 20 μm; and the surface processing is configured to reduce the Ra to no more than 10 μm, 5 μm, 4 μm, 3 μm, 2 μm, or 1 μm.

As another example, some additively manufactured objects may have a relatively high degree of porosity, which may lead to unwanted infiltration of fluids, microorganisms, and/or other contaminants. Porosity can be quantified as the percentage of the volume of voids over the total volume of the object. In some embodiments, the object has an initial porosity of at least 1%, 1.5%, 2%, 2.5%, 3%, 3.5%, 4% 4.5%, or 5%; and the surface processing is configured to reduce the porosity to no more than 1%, 0.75%, 0.5%, 0.25%, 0.1%, or 0.05%.

In a further example, the surface modification process of block 106 can include applying one or more materials to the object surface, such as a coating (e.g., a polymeric coating). The coating can be applied to one or more surfaces of the object for various purposes, including, but not limited to: providing a smooth surface finish, which can be beneficial for aesthetics and/or to improve user comfort if the object is intended to be in contact with the user's body (e.g., a dental appliance worn on the teeth); coloring and/or applying other aesthetic features to the object; improving scratch resistance and/or other mechanical properties; providing antimicrobial properties; and incorporating therapeutic agents into the object for controlled release.

The surface modification process of block 106 can be performed in many different ways. For example, in some embodiments, the surface of the object is mechanically deformed (e.g., plastically deformed) and/or abraded by applying a suitable medium to the object, such as a solid medium (e.g., particles), a fluid medium (e.g., pressurized fluid such as pressurized air), or suitable combinations thereof (e.g., a slurry of particles in a pressurized fluid). As another example, the surface of the object can be softened, melted, or otherwise deformed via the application of heat. In a further example, surface modification can be accomplished through chemical processes (e.g., vapor polishing, solvents, vapor deposition). Additional details of techniques suitable for surface modification of additively manufactured objects are described in Section II below.

At block 108, the method 100 can optionally include performing additional post-processing of the object. Examples of such processes include, but are not limited to, cleaning the object (e.g., washing), post-curing the additively manufactured object, trimming or otherwise separating the object from any substrates, supports, and/or other structures that are not intended to be present in the final product, and packaging the object for shipment.

For instance, post-curing can be used in embodiments where the object is still in a partially cured “green” state after the additive manufacturing process of block 102. Accordingly, the post-curing step may increase the degree of curing of the object to a final, usable state. Post-curing can provide various benefits, such as improving the material properties (e.g., stiffness, strength, glass transition temperature) and/or temperature stability of the object. Post-curing can be performed by applying energy (e.g., UV, visible, infrared, microwave) to the object, or suitable combinations thereof. In other embodiments, however, post-curing is optional and can be omitted.

As another example, the process of block 108 can include separating the object from a substrate. In some embodiments, the substrate is a build platform which mechanically supports the object during fabrication and the post-processing steps described herein. The additively manufactured object can be connected to the substrate via a sacrificial region of material (e.g., supports and/or a raft). Accordingly, the object can be detached from the substrate, e.g., by applying pressure to fracture the sacrificial region. In other embodiments, however, the object may be fabricated without any sacrificial regions.

The method 100 illustrated in FIG. 1 can be modified in many different ways. For example, although the above steps of the method 100 are described with respect to a single object, the method 100 can be used to sequentially or concurrently fabricate and post-process any suitable number of objects, such as tens, hundreds, or thousands of additively manufactured objects. As another example, the ordering of the processes shown in FIG. 1 can be varied. Some of the processes of the method 100 can be omitted, such as the process of block 108. The method 100 can also include additional processes not shown in FIG. 1.

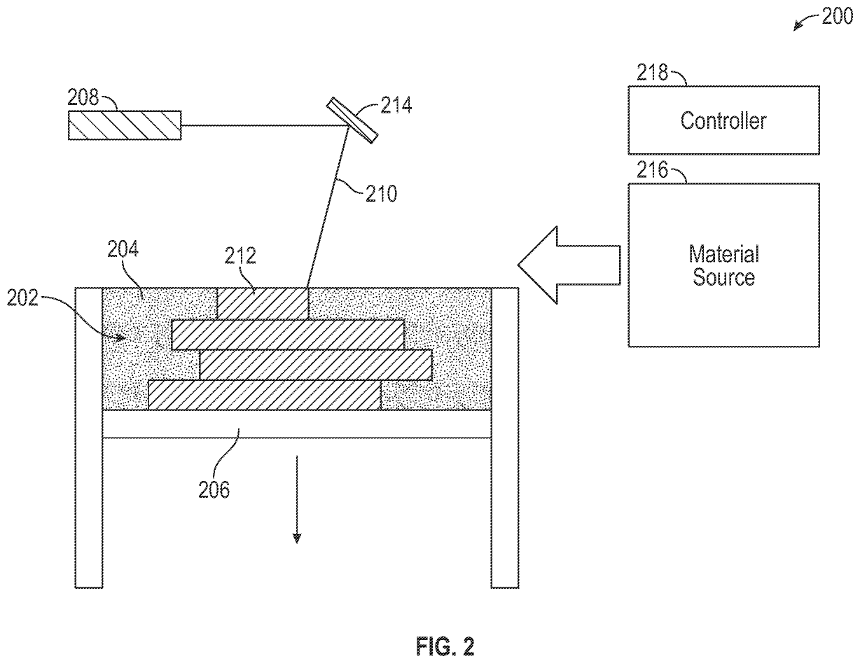

FIG. 2 is a partially schematic diagram of a system 200 for additive manufacturing configured in accordance with embodiments of the present technology. The system 200 can be used to fabricate any embodiment of the additively manufactured objects described herein. For example, the system 200 can be used to produce an object in accordance with block 102 of the method 100 of FIG. 1.

The system 200 is configured to fabricate an additively manufactured object 202 (“object 202”) using a powder bed fusion technique, such as SLS. As shown in FIG. 2, the system 200 includes a bed of powder 204 (e.g., polymeric powder) on a build platform 206. The system 200 also includes an energy source 208 (e.g., a laser source or electron beam source) that outputs energy 210 (e.g., a laser or electron beam) at an intensity configured to sinter, melt, or otherwise fuse the powder 204 into a cohesive object layer 212 on the build platform 206 and/or a previously formed portion of the object 202. A scanner 214 (e.g., a mirror and/or other optical elements) can be used to direct the energy 210 into a suitable pattern on the powder 204 to form the object layer 212. The geometry of the object layer 212 can correspond to the desired geometry for a corresponding cross-section of the object 202.

Once the object layer 212 has been formed, the build platform 206 can be lowered by a predetermined amount. A material source 216 (shown schematically) can then apply a fresh layer of powder 204 onto the formed object layer 212 and previously deposited powder 204. For example, the material source 216 can include a reservoir of powder 204 (e.g., hopper, feed cartridge with movable piston) and/or a smoothing device (e.g., doctor blades, recoater blades, rollers) that applies and smooths the deposited powder 204 into a relatively thin, uniform layer. The fabrication process can be repeated to iteratively build up individual object layers 212 on the build platform 206 until the object 202 is complete. The object 202 can then be removed from the system 200 for post-processing.

In some embodiments, the system 200 also includes a controller 218 that is operably coupled to the build platform 206, energy source 208, and material source 216 to control the operation thereof. The controller 218 can be or include a computing device including one or more processors and memory storing instructions for performing the additive manufacturing operations described herein. For example, the controller 218 can receive a digital data set (e.g., a 3D model) representing the object 202 to be fabricated, determine a plurality of object cross-sections to build up the object 202 from the powder 204, and can transmit instructions to the energy source 208 to output energy 210 to form a plurality of object layers 212 corresponding to object cross-sections. Additionally, the controller 218 can also determine and control other operational parameters, such as the positioning of the build platform 206 (e.g., height) and/or the amount of powder 204 deposited by the material source 216.

Although FIG. 2 illustrates a representative example of a system 200 for additive manufacturing, this is not intended to be limiting, and the methods described herein can be implemented using other types of additive manufacturing systems, such as vat photopolymerization systems, material jetting systems, binder jetting systems, FDM systems, sheet lamination systems, or directed energy deposition systems.

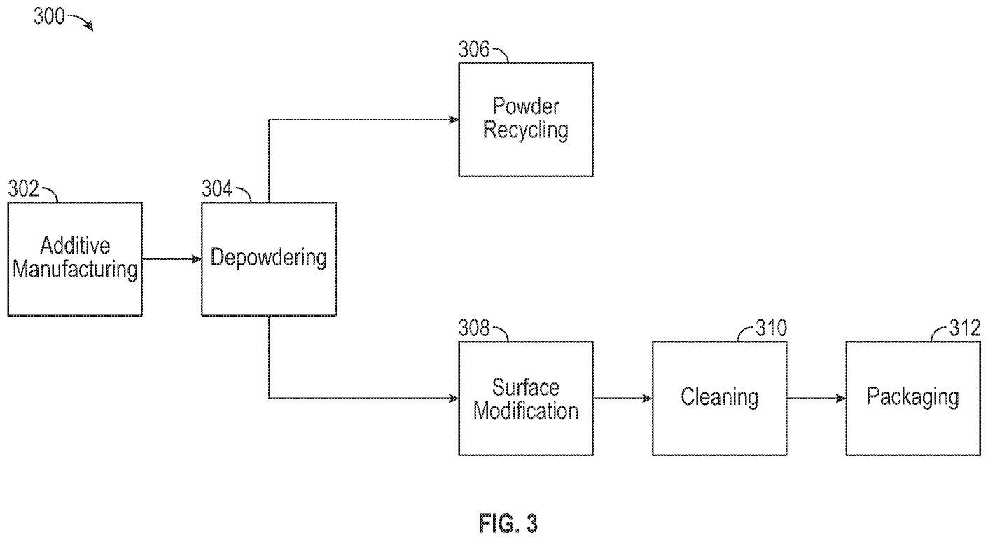

FIG. 3 is a schematic diagram of a system 300 for fabricating and processing additively manufactured objects, in accordance with embodiments of the present technology. The system 300 can be used to fabricate any embodiment of the additively manufactured objects described herein. For example, the system 300 can be used to produce and post-process an object in accordance with the method 100 of FIG. 1.

The system 300 includes an additive manufacturing subsystem 302 configured to fabricate one or more additively manufactured objects using any of the additive manufacturing techniques described herein. For example, the additive manufacturing subsystem 302 can be or include a powder bed fusion system, such as the system 200 of FIG. 2. In such embodiments, the fabricated objects can be transported to a depowdering subsystem 304 to remove excess powder before subsequent post-processing. The depowdering subsystem 304 can include mechanisms that use any suitable combination of mechanical motion (e.g., vibration, rotation, agitation), pressurized gas (e.g., compressed air), vacuum, brushes, etc., to remove the powder from the object. Optionally, the removed powder can be processed by a powder recycling subsystem 306 for reuse. In some embodiments, the powder recycling subsystem 306 is configured to filter out contaminants from the removed powder, mix the removed powder with fresh powder, perform powder conditioning, and/or other suitable operations to prepare the powder for subsequent use by the additive manufacturing subsystem 302.

The objects fabricated by the additive manufacturing subsystem 302 are transported to a surface modification subsystem 308. As described in greater detail below, the surface modification subsystem 308 can be configured to alter one or more surface characteristics of the objects, such as surface roughness, porosity, visual appearance, hydrophobicity, chemical reactivity, etc.

Subsequently, the objects can be transported to a cleaning subsystem 310 to remove debris, contaminants, and/or any other unwanted material. For example, the cleaning subsystem 310 can include mechanisms to wash the objects via ultrasonic cleaning techniques, solvents, heated fluids, and/or suitable combinations thereof. The objects can then be transported to a packaging subsystem 312 to be packaged for shipment and use.

The system 300 illustrated in FIG. 3 can be modified in various ways. For example, although the illustrated embodiment is configured for processing objects fabricated using a powder bed fusion technique, this is not intended to be limiting, and the system 300 can be adapted for objects fabricated using other types of additive manufacturing techniques. Moreover, any of the subsystems 302-312 shown in FIG. 3 can be combined with each other to form a larger subsystem, or can be subdivided into smaller subsystems.

Additionally, the system 300 can include other components not shown in FIG. 3. For instance, the system 300 can include mechanisms for transporting objects and/or powder between any of the subsystems 302-312, such as conveyer belts, robotic assemblies, and the like. The system 300 can also include one or more controllers configured to monitor and control any of the operations performed by the subsystems 302-312. In some embodiments, the system 300 includes additional subsystems for post-curing, separating the objects from substrates, and/or other applicable post-processing operations.

### II. Surface Modification of Additively Manufactured Objects

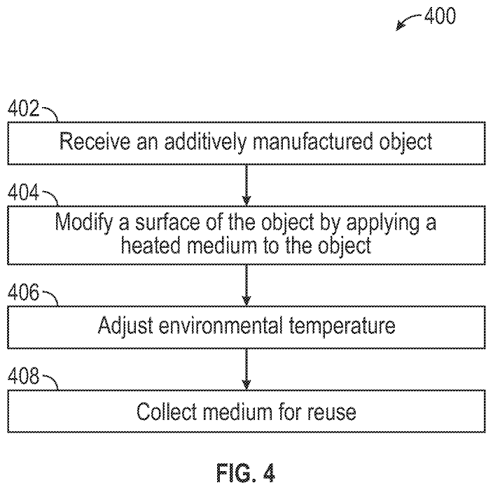

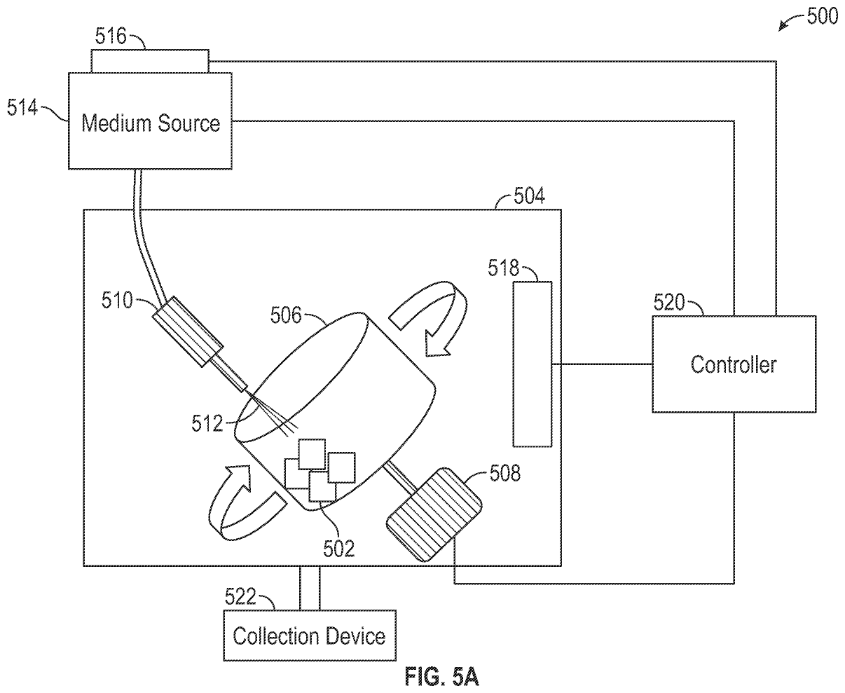

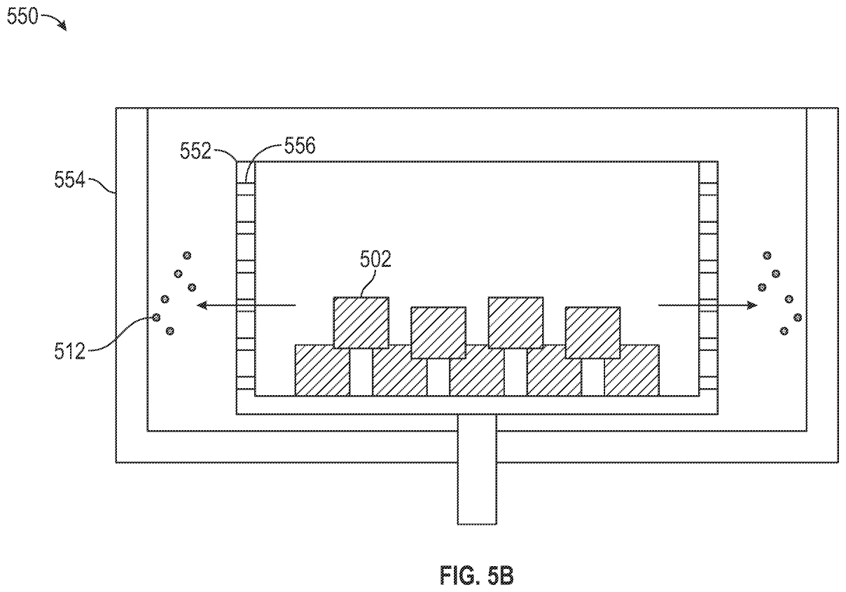

FIG. 4 is a flow diagram illustrating a method 400 for processing an additively manufactured object, in accordance with embodiments of the present technology. The method 400 can be performed using any suitable system or device, such as the embodiments described below in connection with FIGS. 5A and 5B. In some embodiment, some or all of the processes of the method 400 are implemented as computer-readable instructions (e.g., program code) that are configured to be executed by one or more processors of a computing device. The method 400 can be combined with any of the other methods described herein, such as the method 100 of FIG. 1.

The method 400 begins at block 402 with receiving an additively manufactured object. In some embodiments, the object is a dental appliance, such as an aligner, palatal expander, retainer, etc. The object can be fabricated using any of the additive manufacturing techniques described herein, and can be made from any suitable material or combination of materials. In some embodiments, for example, the object is made partially or entirely out of a thermoplastic material, such as a polyamide (e.g., nylon), a thermoplastic polyester, a polycarbonate, a thermoplastic polyurethane, a polypropylene, a polyethylene, an acrylic, a polyetheretherketone, a polyethylene terephthalate, a polybutylene terephthalate, a polytrimethylene terephthalate, a polyetherimide, a polyethersulfone, a styrenic block copolymer (SBC), a thermoplastic elastomer (TPE), a thermoplastic vulcanizate (TPV) elastomer, a block copolymer elastomer, a polyolefin blend elastomer, a thermoplastic co-polyester elastomer, a thermoplastic polyamide elastomer, or suitable copolymers or combinations thereof. In embodiments where the object is intended for use on or within the patient's body (e.g., the intraoral cavity), the material can be a biocompatible material.

At block 404, the method 400 continues with modifying a surface of the object by applying a heated medium to the object. The medium can be any material that can be used to modify the surface of the object via mechanical force, such as mechanical deformation (e.g., plastic deformation) and/or abrasion. For example, the medium can be a solid medium (e.g., a plurality of particles), a fluid medium (e.g., a pressurized fluid), or a combination thereof (e.g., a slurry of particles in a fluid). The medium can be an abrasive medium that produces both mechanical deformation and abrasion of the object surface, or can be a non-abrasive medium that produces mechanical deformation without abrasion of the object surface.

In some embodiments, for example, the medium is or includes a blasting medium including a plurality of particles (e.g., beads, shot, grit, powder) configured to be pressurized and propelled against the object surface to cause mechanical deformation and/or abrasion. In such embodiments, the particles can be pressurized by mixing with a high-pressure gas (e.g., air) to a pressure of at least 50 psi, 60 psi, 70 psi, 80 psi, 90 psi, 100 psi, 110 psi, 120 psi, 130 psi, 140 psi, or 150 psi. The appropriate pressure level can be selected based on the characteristics of the material used to form the object (e.g., hardness, elastic limit), the initial surface characteristics of the object (e.g., initial surface roughness and/or porosity), the target surface characteristics for the object (e.g., target roughness and/or porosity), the type of medium used, the target processing time (e.g., higher pressures may allow for faster processing), and/or any other relevant considerations.

The medium can be heated to a first elevated temperature (e.g., above room temperature) before being applied to the object. This approach can be beneficial for facilitating mechanical deformation of materials with temperature-dependent properties, such as thermoplastics. The first elevated temperature can be selected based on the characteristics of the material used to form the object (e.g., glass transition temperature (T_{g}), melting point), the initial surface characteristics for the object (e.g., target roughness and/or porosity), the type of medium used, the target processing time (e.g., higher temperatures may allow for faster processing), and/or any other relevant considerations.

For example, the first elevated temperature can be greater than or equal to a T_{g} of the material used to form the object. In some embodiments, the object is fabricated partially or entirely from a material having a T_{g} of at least 40° C., 50° C., 60° C., 70° C., 80° C., 90° C., 100° C., 110° C., 120° C., 130° C., 140° C., 150° C., 175° C., or 200° C.; and the medium is heated to a temperature that is at least 5° C., 10° C., 15° C., 20° C., 25° C., 30° C., 35° C., 40° C., 45° C., or 50° C. greater than the T_{g} of the material. For example, the medium can be heated to a temperature within a range from 30° C. to 250° C., or within a range from 50° C. to 200° C., such as a temperature of at least 60° C., 70° C., 80° C., 90° C., 100° C., 110° C., 120° C., 130° C., 140° C., 150° C., 160° C., 170° C., 180° C., or 190° C.

The first elevated temperature can be less than a melting point of the material used to form the object. For example, the object can be fabricated partially or entirely from a material having a melting point less than or equal to 300° C., 275° C., 250° C., 225° C., 200° C., 175° C., 150° C., 125° C., 100° C., or 75° C.; and the medium can be heated to a temperature that is at least 5° C., 10° C., 15° C., 20° C., 25° C., 30° C., 35° C., 40° C., 45° C., or 50° C. less than the melting point of the material. In some embodiments, the medium is heated to a temperature of no more than 250° C., 225° C., 200° C., 190° C., 180° C., 170° C., 160° C., 150° C., 140° C., 130° C., 120° C., 110° C., 100° C., 90° C., or 80° C.

The medium can be composed partially or entirely out of a thermally conductive material configured to enhance transfer of thermal energy to the object surface. For example, the medium can be composed partially or entirely out of a metal (e.g., stainless steel, aluminum, copper), a ceramic (e.g., sialon (alumino-silicate oxynitride), silicon carbide), a composite (e.g., a polyimide composite), or suitable combinations thereof. In some embodiments, the medium is composed partially or entirely out of a material having a thermal conductivity within a range from 1 W/mK to 400 W/mK, such as a thermal conductivity of at least 50 W/mK, 100 W/mK, 150 W/mK, 200 W/mK, 250 W/mK, 300 W/mK, or 350 W/mK.

The other properties of the medium (e.g., hardness, size, shape, friability) can be varied as desired, and can be selected based on factors such as the types of the material(s) used to form the object (e.g., the hardness of the object), the target surface characteristics of the object (e.g., target roughness and/or porosity), reusability, cost, and/or environmental conditions (e.g., temperature, pressure). For example, the medium can have a hardness (e.g., Mohs scale) of at least 3.0, 3.5, 4.0, 4.5, 5.0, 5.5, 6.0, 6.5, 7.0, 7.5, 8.0, 8.5, 9, or 9.5. The medium can have a particle size (e.g., average particle diameter) within a range from 50 μm to 2 mm, such as a particle size less than or equal to 1.5 mm, 1 mm, 900 μm, 800 μm, 700 μm, 600 μm, 500 μm, 400 μm, 300 μm, 200 μm, or 100 μm. The shape of the medium can be angular, sub-angular, sub-rounded, or rounded. The friability of the medium can refer to its tendency to break up during use, and can correspond to reusability in that more friable media may have limited reusability or be non-reusable, while less friable media may be reusable. Reusability can be quantified in various ways, such as the number of times the medium can be reused in a surface modification process. In some embodiments, for example, the medium is suitable for at least 10 uses, 20 uses, 30 uses, 40 uses, 50 uses, 60 uses, 70 uses, 80 uses, 90 uses, or 100 uses.

The medium can be applied to any suitable portion of the object, such as some or all of the exterior surfaces of the object and/or some or all of the interior surfaces of the object. For example, in embodiments where the object is a dental appliance configured to be worn on a patient's teeth, the medium can be applied to any of the following portions of the appliance: a buccal surface, a lingual surface, an occlusal surface, a surface configured to be positioned adjacent or near the patient's teeth, a surface configured to be positioned adjacent or near the patient's gingiva, a surface configured to be positioned adjacent or near the patient's palate, a surface configured to be positioned adjacent or near the patient's tongue, or suitable combinations thereof.

In some embodiments, the object is rotated, translated, tumbled, vibrated, or otherwise moved while the medium is being applied so as to expose multiple different surfaces of the object to the medium. The motion can be applied via a tumbler (e.g., an agitatable drum), moving platform, robotic arm, and/or any other suitable actuation mechanism. Alternatively, the object can be held in a fixed position and/or orientation so that only some of the object surfaces are exposed to the medium. This approach allows certain surfaces to be selectively modified by the medium, while the other surfaces remain unmodified; and/or allows different modifications to be applied to different surfaces of the object.

At block 406, the method 400 can optionally include adjusting an environmental temperature while the heated medium is being applied to the object. For example, the environment surrounding the object can be heated to a second elevated temperature (e.g., above room temperature) to further enhance mechanical deformation of the object surface and/or to reduce loss of thermal energy from the system. The second elevated temperature can be the same as the first elevated temperature of block 404, or can be different (e.g., less than or greater than) the first elevated temperature. For example, the second elevated temperature can be at least 5° C., 10° C., 15° C., 20° C., 25° C., 30° C., 35° C., 40° C., 45° C., or 50° C. less than or greater than the first elevated temperature. In some embodiments, the second elevated temperature is within a range from 30° C. to 100° C., such as a temperature of at least 40° C., 50° C., 60° C., 70° C., 80° C., 90° C., or 100° C.

Optionally, the second elevated temperature can be selected based on the characteristics of the material used to form the object, the initial surface characteristics of the object, the target surface characteristics for the object, the type of medium used, the first elevated temperature to which the medium is heated, the target processing time, and/or any other relevant considerations. For example, the second elevated temperature can be greater than, equal to, or less than the T_{g} of the material; and/or can be less than the melting point of the material. In other embodiments, however, the process of block 406 can be omitted, such that the environmental temperature is uncontrolled or allowed to remain at ambient temperature during processing.

The surface characteristics of the object after the processes of blocks 404 and/or 406 can be varied as desired, depending on the intended use of the object. In some embodiments, for example, the object has at least one surface with an initial Ra of at least 5 μm, 10 μm, 15 μm, or 20 μm; and the processes of blocks 404 and/or 406 are configured to reduce the Ra to no more than 10 μm, 5 μm, 4 μm, 3 μm, 2 μm, or 1 μm. As another example, the object can have at least one surface with an initial porosity of at least 1%, 1.5%, 2%, 2.5%, 3%, 3.5%, 4% 4.5%, or 5%; and the processes of blocks 404 and/or 406 are configured to reduce the porosity to no more than 1%, 0.75%, 0.5%, 0.25%, 0.1%, or 0.05%.

At block 408, the method 400 can include collecting the medium for reuse. As discussed above, the medium can be a reusable medium having a relatively low friability, such as a metal or a high strength ceramic. In such embodiments, after the medium has been applied to the object, it can be collected for reuse in the same surface modification process or a subsequent surface modification process. Optionally, the medium can be washed, filtered, mixed with fresh medium, and/or otherwise processed before reuse. In other embodiments, however, the process of block 408 can be omitted.

The method 400 can be modified in many different ways. For example, although the above steps of the method 400 are described with respect to a single object, the method 400 can be used to sequentially or concurrently process any suitable number of objects, such as tens, hundreds, or thousands of additively manufactured objects. In some embodiments, the objects are associated with a single individual (e.g., a series of dental appliances used to treat a single patient), while in other embodiments, the objects can be associated with multiple individuals (e.g., a batch of dental appliances for a plurality of patients). As another example, the ordering of the processes shown in FIG. 4 can be varied. Some of the processes of the method 400 can be omitted, such as the processes of blocks 406 and/or 408. The method 400 can also include additional processes not shown in FIG. 4.

FIG. 5A is a partially schematic diagram of a system 500 for processing one or more additively manufactured objects 502, in accordance with embodiments of the present technology. The system 500 can be used to implement any of the methods described herein, such as the method 400 of FIG. 4. Additionally, the system 500 can be used in combination with any of the other systems and devices described herein. For example, the system 500 can be part of the surface modification subsystem 308 of FIG. 3.

The system 500 includes a chamber 504 housing a receptacle 506 configured to receive one or more objects 502 (e.g., one, two, three, four, five, 10, 20, 30, 40, 50, or more objects 502). The receptacle 506 can be operably coupled to an actuator 508 (e.g., a motor) that is configured to actuate (e.g., rotate, translate, vibrate, agitate) the receptacle 506 and the objects 502. In the illustrated embodiment, for example, the receptacle 506 is configured as a tumbler including a barrel (also referred to herein as a “drum”) containing the objects 502, and the actuator 508 is configured to rotate and/or vibrate the barrel. For example, the barrel can be rotated at a speed of at least 1 RPM, 5 RPM, 10 RPM, 20 RPM, 30 RPM, 40 RPM, or 50 RPM. The objects 502 can be loose within the barrel, such that the rotation and/or vibration of the barrel causes the objects 502 to tumble. This configuration can allow multiple or all of the surfaces of the objects 502 to be modified, as described further below. In other embodiments, however, the receptacle 506 can be configured differently. For instance, the receptacle 506 can instead be a movable or stationary platform (e.g., plate, tray), and the objects 502 can be supported (e.g., fixed in a stationary position and/or orientation) on a surface of the platform. This configuration can be used in situations where only certain object surfaces are to be modified and/or different processing parameters are to be used for modifying different object surfaces.

The system 500 includes at least one applicator 510 (e.g., a nozzle) configured to direct a blasting medium 512 (e.g., a plurality of metallic and/or ceramic particles) toward the objects 502 held by the receptacle 506. The applicator 510 can be connected to a source 514 of the blasting medium 512 (e.g., a hopper, bucket, reservoir, or other container—shown schematically). In some embodiments, the source 514 is pressurized so that the blasting medium 512 is propelled from the applicator 510 and onto the objects 502 at a sufficiently high pressure to produce mechanical deformation and/or abrasion of the object surfaces. For example, the pressure can be at least at least 50 psi, 60 psi, 70 psi, 80 psi, 90 psi, 100 psi, 110 psi, 120 psi, 130 psi, 140 psi, or 150 psi. In some embodiments, the applicator 510 is a stationary device, such that the blasting medium 512 is applied to the objects 502 from a single fixed direction. Alternatively, the applicator 510 can be movable (e.g., rotated and/or translated), such that the blasting medium 512 can be applied to the objects 502 from different directions.

Although FIG. 5A illustrates a single applicator 510, in other embodiments, the system 500 can include a plurality of applicators 510 (e.g., at least two, three, four, five, or more applicators 510) at different positions and/or orientations relative to the receptacle 506. For example, any of the applicators 510 can be positioned at or near the upper portion of the chamber 504, the bottom portion of the chamber 504, or a sidewall of the chamber 504. In such embodiments, some or all of the applicators 510 can be configured to apply the same type of blasting medium 512, or some or all of the applicators 510 can be configured to apply different types of blasting media 512. In embodiments where multiple types of blasting media 512 are used, the system 500 can include multiple medium sources 514.

The source 514 can include or be coupled to at least one first heating element 516 configured to heat the blasting medium 512 to a first elevated temperature. As previously described, the first elevated temperature can be within a range from 30° C. to 250° C., or within a range from 50° C. to 200° C., such as a temperature of at least 60° C., 70° C., 80° C., 90° C., 100° C., 110° C., 120° C., 130° C., 140° C., 150° C., 160° C., 170° C., 180° C., or 190° C. The first heating element 516 can be or include any suitable device, such as a heated fluid source, an induction heater (e.g., in embodiments where the blasting medium 512 includes a metallic material), a thermoelectric heater, or a heat pump. The first heating element 516 can be thermally coupled to the source 514 of the blasting medium 512 in various ways, e.g., the first heating element 516 can be positioned within the source 514, attached to an exterior wall of the source 514, thermally coupled to a fluid that circulates into or near the source 514, etc. Although FIG. 5A illustrates a single first heating element 516, in other embodiments, the system 500 can include multiple first heating elements 516 (e.g., two, three, four, five, or more first heating elements 516), which can be positioned at various locations relative to the source 514.

Optionally, the system 500 can include a second heating element 518 configured to heat the environment within the chamber 504 to a second elevated temperature. As previously described, the second elevated temperature can be the same as or different from the first elevated temperature. For example, the second elevated temperature can be within a range from 30° C. to 100° C., such as a temperature of at least 40° C., 50° C., 60° C., 70° C., 80° C., 90° C., or 100° C. The second heating element 518 can be or include any suitable device, such as a heated fluid source, a thermoelectric heater, or a heat pump. Although the second heating element 518 is illustrated as being positioned within the chamber 504 near a sidewall, in other embodiments, the second heating element 518 can be arranged differently. For example, the second heating element 518 can be positioned within the chamber 504 at a different location (e.g., near the upper portion of the chamber 504, near the lower portion of the chamber 504), can be positioned outside the chamber 504, can be thermally coupled to a fluid that circulates into the chamber 504, etc. Additionally, although FIG. 5A illustrates a single second heating element 518 in other embodiments, the system 500 can include multiple second heating elements 518 (e.g., two, three, four, five, or more second heating elements 518), which can be positioned at various locations relative to the chamber 504.

The system 500 can include a controller 520 configured to control the operations of the other components of the system 500, e.g., via one or more control signals. For example, the controller 520 can be operably coupled to the actuator 508, applicator 510, medium source 514, first heating element 516, and/or second heating element 518. The controller 520 can be or include a computing device including one or more processors and memory storing instructions for performing any of the following operations: controlling the actuation of the receptacle 506 via the actuator 508 (e.g., rotation speed, rotation direction, vibration frequency, vibration amplitude); controlling the application of the blasting medium 512 delivered via the applicator 510 (e.g., with respect to rate, amount, timing, pressurization); controlling the position and/or orientation of the applicator 510 via a corresponding actuator (not shown); controlling the temperature of the blasting medium 512 via the first heating element 516; and/or controlling the temperature of the chamber 504 via the second heating element 518.

For example, in some embodiments, the controller 520 is configured to receive input data (e.g., from a human operator, computing device, database) characterizing the objects 502 to be processed, such as the type of objects 502 (e.g., type of dental appliance), material(s) used to form the objects 502 (e.g., material type; material properties such as hardness, T_{g}, melting point), techniques used to form the objects 502 (e.g., type of additive manufacturing process), the initial characteristics of the objects 502 (e.g., initial surface roughness and/or porosity), the target characteristics for the objects 502 (e.g., target surface roughness and/or porosity), the target processing time, and/or other relevant information. Based on the input data, the controller 520 can determine a set of parameters for processing the objects 502, such as the type(s) of blasting medium 512 used, the pressure level for applying the blasting medium 512, the position and/or orientation of the applicator 510 during blasting, the first elevated temperature for the blasting medium 512, the second elevated temperature for the chamber 504, the actuation parameters for the receptacle 506 (e.g., rotation speed, rotation direction, vibration frequency, vibration amplitude), and/or the amount of time the blasting medium 512 is to be applied. The appropriate parameters can be determined in various ways, such as input manually by an operator; retrieved from a database, lookup table, or other suitable data structure; and/or generated by an automated algorithm (e.g., a rule-based algorithm, a trained machine learning algorithm). The controller 520 can then initiate processing of the objects 502 in accordance with the determined parameters.

Optionally, the system 500 can include one or more sensors (not shown) configured to provide monitoring and feedback during processing. For example, the system 500 can include at least one temperature sensor (e.g., thermocouple, thermistor, infrared camera) configured to measure a temperature of a portion of the system 500. In some embodiments, one or more temperature sensors are located on or within the chamber 504 (e.g., on the upper portion, lower portion, and/or sidewall), on or within the receptacle 506, and/or on or within the medium source 514. The temperature measurements produced by the temperature sensor(s) can be transmitted to the controller 520, and the controller 520 can adjust the heat output of the first heating element 516 and/or the second heating element 518 to maintain the blasting medium 512 and/or chamber 504, respectively, at a desired temperature range.

As another example, the system 500 can include one or more load sensors (e.g., force sensors, weigh sensors, torque sensors) configured to detect whether the receptacle 506 has an excess mechanical load (e.g., an excess force, an excess torque, or a combination thereof). Excess mechanical loads can result from too many additively objects 502 within the receptacle 506 and/or excessive amounts of the blasting medium 512 being retained within the receptacle 506. The load data generated by the load sensor(s) can be transmitted to the controller 520, and the controller 520 can adjust the operation of the receptacle 506 accordingly, such as slowing the movement rate (e.g., rotation rate) of the receptacle 506 or stopping the movement of the receptacle 506, if the detected load exceeds a threshold value indicating that an excess mechanical load is present.

Other types of sensors that can be used to provide feedback to the controller 520 include, but are not limited to, pressure sensors, imaging devices (e.g., cameras), and motion sensors (e.g., accelerometers, gyroscopes). Based on the feedback, the controller 520 can adjust the operations of the various components of the system 500, such as the actuator 508, applicator 510, medium source 514, first heating element 516, and/or second heating element 518.

In some embodiments, the system 500 further includes a collection device 522 (shown schematically) configured to collect used blasting medium 512. The collected blasting medium 512 can be reused (e.g., for processing the same objects 502 or a different set of objects), or can be disposed. The collection device 522 can include containers (e.g., catch pans, reservoirs, hoppers, etc.) configured to hold the blasting medium 512, as well as hoses, pipes, drains, funnels, and/or other structures configured to divert the blasting medium 512 into the containers and/or to other locations in the system 500 (e.g., back to the medium source 514). Additionally, the collection device can include filters, traps, or similar components to separate the blasting medium 512 from debris and/or other contaminants. The blasting medium 512 can be directed into the containers by gravity, vacuum pressure, and/or any other suitable technique. In the illustrated embodiment, for example, the collection device 522 is located at or near the bottom portion of the chamber 504, and the receptacle 506 can include one or more apertures (e.g., holes, perforations) that allow the blasting medium 512 to fall out of the receptacle 506 via gravity and toward the collection device 522. In other embodiments, the collection device 522 can be arranged differently (e.g., can be located at a different portion of the chamber 504, can be part of another component such as the receptacle 506) and/or other mechanisms can be used to direct the used blasting medium 512 into the collection device 522.

FIG. 5B is a partially schematic diagram of a receptacle 550 configured in accordance with embodiments of the present technology. The receptacle 550 can be used in combination with any of the systems described herein. For example, the receptacle 550 can be used as the receptacle 506 of the system 500 of FIG. 5A. The receptacle 550 can be configured to hold one or more additively manufactured objects 502 (e.g., one, two, three, four, five, 10, 20, 30, 40, 50, or more objects 502). In the illustrated embodiment, the receptacle 550 is configured as a drum or barrel including an inner portion 552 and an outer portion 554. The inner portion 552 and outer portion 554 can both be actuated (e.g., rotated, translated, vibrated, agitated), or the inner portion 552 can be actuated while the outer portion 554 remains stationary.

The inner portion 552 can be an inner drum or barrel that receives the additively manufactured objects 502. The upper section of the inner portion 552 can be open to allow the blasting medium 512 to be applied onto the objects 502 (e.g., via the applicator 510 of FIG. 5A), as described elsewhere herein. In some embodiments, the inner portion 522 is configured to allow excess blasting medium 512 to be removed. For example, the inner portion 552 can include a plurality of perforations 556 that are sized to retain the objects 502 inside the inner portion 552, while allowing the blasting medium 512 to pass through. The blasting medium 512 can exit through the perforations 556 due to blasting forces, gravity, motion of the inner portion 522, or combinations thereof. Although FIG. 5B depicts the perforations 556 as being located in the sidewalls of the inner portion 552, the perforations 556 can alternatively or additionally be located in other sections of the inner portion 552, such in the bottom wall of the inner portion 552.

The outer portion 554 can be an outer drum or barrel that receives and surrounds the inner portion 552. In some embodiments, the outer portion 554 is configured to collect the blasting medium 512 that has exited the inner portion 552 (e.g., the outer portion 554 can be part of or can replace the collection device 522 of the system 500 of FIG. 5A). Accordingly, the outer portion 554 may not include any perforations, or any perforations that are present in the outer portion 554 may be smaller than the size of the blasting medium 512 to prevent the blasting medium 512 from exiting the outer portion 554. Optionally, the outer portion 554 can be coupled to hoses, pipes, drains, funnels, etc., that are configured to divert the blasting medium 512 to another location, such as to a separate collection container (e.g., the collection device 522 of FIG. 5A) or back to a medium source (e.g., the medium source 514 of FIG. 5A).

In some embodiments, the receptacle 550 is operably coupled to one or more load sensors that monitor whether an excess mechanical load is present in the receptacle 550 (e.g., in the inner portion 552 of the receptacle 550). For instance, an excess mechanical load may be present if some or all of the blasting medium 512 that is applied to the objects 502 does not exit through the perforations 556 of the inner portion 552, and is instead being retained within the inner portion 552. As described herein, the operation of the receptacle 550 can be adjusted if an excess mechanical load is detected (e.g., by slowing or stopping the movement of the receptacle 550).

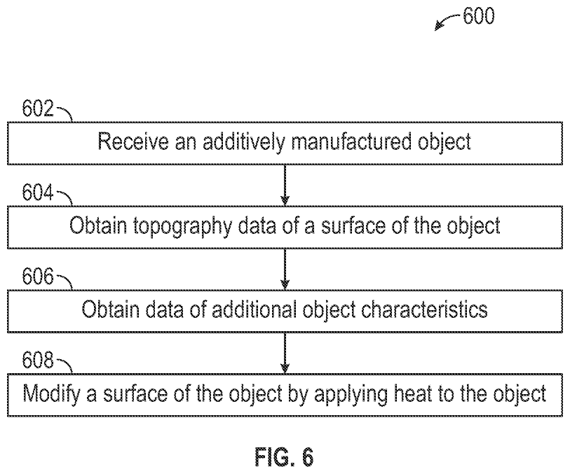

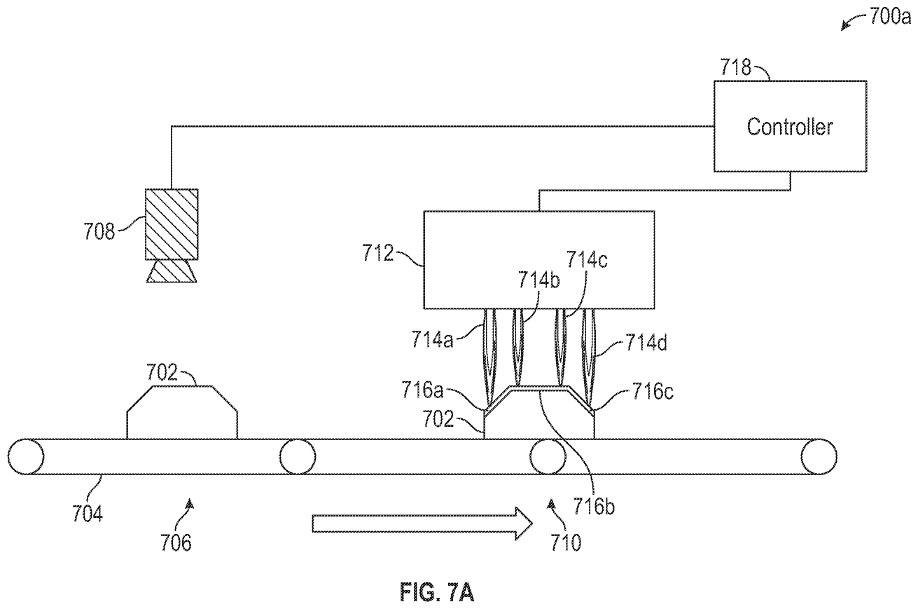

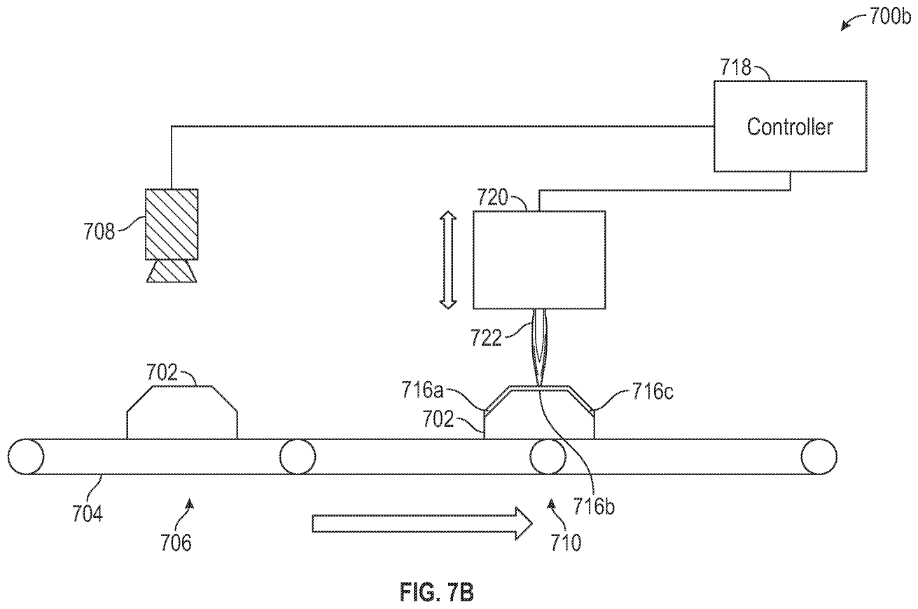

FIG. 6 is a flow diagram illustrating another method 600 for processing an additively manufactured object, in accordance with embodiments of the present technology. The method 600 can be performed using any suitable system or device, such as the embodiments described below in connection with FIGS. 7A and 7B. In some embodiment, some or all of the processes of the method 600 are implemented as computer-readable instructions (e.g., program code) that are configured to be executed by one or more processors of a computing device. The method 600 can be combined with any of the other methods described herein, such as the method 100 of FIG. 1 and/or the method 400 of FIG. 4.

The method 600 begins at block 602 with receiving an additively manufactured object. In some embodiments, the object is a dental appliance, such as an aligner, palatal expander, retainer, etc. The object can be fabricated using any of the additive manufacturing techniques described herein, and can be made from any suitable material or combination of materials, such as any of the materials previously described with respect to block 402 of the method 400 of FIG. 4. In some embodiments, for example, the object is made partially or entirely out of a thermoplastic material. As another example, the object can be made partially or entirely out of a thermoset material, such as a thermosetting resin. The material can be a biocompatible material suitable for use on or within the patient's body.

At block 604, the method 600 includes obtaining topography data of a surface of the object. The topography data can characterize the geometry (e.g., shape, contours, feature size) of the object surface. For example, in embodiments where the object is an orthodontic appliance, the topography data can characterize the geometry of the appliance over a lingual surface, a buccal surface, an occlusal surface, a palatal surface, an inner surface, an outer surface, an upper surface, a lower surface, a lateral surface, or suitable combinations thereof. The topography data can be obtained using at least one sensor, such as one or more of the following sensor types: imaging devices (e.g., cameras, scanners), distance sensors (e.g., ultrasonic sensors, infrared sensors, time-of-flight sensors, rangefinders), or combinations thereof.

In some embodiments, the topography data includes or is used to determine a height profile or distribution for the object. The height of the object can be measured at one or more points on the object, along one or more lines across the object, and/or over one or more regions of the object. The height can be measured relative to a reference height, such as the height of a specified location on the object and/or on a substrate supporting the object.

At block 606, the method 600 can optionally include obtaining data of at least one additional object characteristic. The additional characteristics can include any of the following: the type of object (e.g., type of dental appliance), the geometry of the object (e.g., object thickness, locations of different functional portions), the type of material used to form the object, the properties of the material (e.g., T_{g}, melting point), the locations of different materials in the object (in embodiments where the object is formed from multiple types of materials), and/or the initial surface characteristics of the object (e.g., initial roughness and/or porosity).

The data of the additional characteristics can be obtained in various ways. For example, the data of the additional characteristics can be received from a database, computing device or system (e.g., a server), or other suitable data source. In some embodiments, the object has one or more customized characteristics (e.g., for a particular appliance type, patient, treatment stage, etc.), and the process of block 606 further includes receiving a unique identifier for the object, and then retrieving the data of the customized characteristics based on the identifier. For example, the identifier can be received from a label, tag (e.g., RFID tag), code (e.g., barcode), etc., that is associated with the object (e.g., embedded in or attached to the object, embedded in or attached to a substrate or other structure supporting the object). The identifier can be determined using a suitable sensor, such as an RFID reader, barcode scanner, etc. The identifier can then be used to locate and retrieve the data of the customized characteristics of the object, e.g., from a database, server, or other suitable data source.

Alternatively or in combination, the additional characteristics can be obtained using other techniques. For instance, some or all of the additional characteristics can be determined based on sensor data from one or more sensors, such as imaging devices, optical sensors, chemical sensors, etc. In such embodiments, the sensor(s) can be the same as the sensor(s) used to obtain the topography data in block 604, or can be different sensor(s). Optionally, the data of the additional characteristics can be provided via input by a human operator.

At block 608, the method 600 includes modifying a surface of the object by applying heat to the object. The heat can soften and/or melt the material at or near the object surface to alter the surface characteristics, such as by reducing surface roughness, sealing surface pores, etc. The extent of softening and/or melting can be sufficiently deep to produce the desired surface modifications, but not so deep as to detrimentally affect the macroscopic structure and/or mechanical properties of the object. For example, the object can be softened and/or melted to a depth of at least 5 μm, 10 μm, 20 μm, 30 μm, 40 μm, or 50 μm; and/or to a depth of no more than 100 μm, 75 μm, 50 μm, or 25 μm. In some embodiments, the depth of softening and/or melting (also referred to herein as the “treatment depth”) can be substantially uniform over the entire modified surface of the object (e.g., no more than 10%, 5%, or 1% variation in treatment depth). Alternatively, the treatment depth can be variable over the surface of the object, e.g., some portions of the surface can have a greater treatment depth than other portions. The treatment depth can be selected based on the target surface characteristics for each object portion, the material composition of each object portion, the intended function of each object portion, and/or any other suitable factor.

The heat can be applied using any suitable heating element, such as a flame generator, plasma generator, corona generator, etc. The heating element can be configured to heat the surface of the object and/or portions of the object near the surface to a target temperature (e.g., maximum, minimum, and/or average temperature). The target temperature can be selected based on the characteristics of the material used to form the object (e.g., T_{g}, melting point), the initial surface characteristics for the object (e.g., target roughness and/or porosity), the type of medium used, the target processing time (e.g., higher temperatures may allow for faster processing), and/or any other relevant considerations.

For example, the target temperature can be greater than or equal to a T_{g} of the material used to form the object. In some embodiments, the object is fabricated partially or entirely from a material having a T_{g} of at least 40° C., 50° C., 60° C., 70° C., 80° C., 90° C., 100° C., 110° C., 120° C., 130° C., 140° C., 150° C., 175° C., or 200° C.; and the target temperature is at least 5° C., 10° C., 15° C., 20° C., 25° C., 30° C., 35° C., 40° C., 45° C., or 50° C. greater than the T_{g} of the material. Alternatively or in combination, the object can be fabricated partially or entirely from a material having a melting point greater than or equal to 75° C., 100° C., 125° C., 150° C., 175° C., 200° C., 225° C., 250° C., 275° C., or 300° C. The target temperature can be at least 5° C., 10° C., 15° C., 20° C., 25° C., 30° C., 35° C., 40° C., 45° C., or 50° C. greater than or less than the melting point of the material. In some embodiments, the target temperature is within a range from 30° C. to 250° C., or from 50° C. to 300° C., such as a temperature of at least 75° C., 100° C., 125° C., 150° C., 175° C., 200° C., 225° C., 250° C., or 275° C.

The heat can be applied to any suitable portion of the object, such as some or all of the exterior surfaces of the object and/or some or all of the interior surfaces of the object. For example, in embodiments where the object is a dental appliance configured to be worn on a patient's teeth, the heat can be applied to any of the following portions of the appliance: a buccal surface, a lingual surface, an occlusal surface, a surface configured to be positioned adjacent or near the patient's teeth, a surface configured to be positioned adjacent or near the patient's gingiva, a surface configured to be positioned adjacent or near the patient's palate, a surface configured to be positioned adjacent or near the patient's tongue, or suitable combinations thereof. In embodiments where multiple object surfaces are to be treated, the heat can be applied to the surfaces sequentially or concurrently. Optionally, certain surfaces of the object can be selectively heated, while other surfaces are unheated and thus remain unmodified.

The heat can be applied to the object based on the topography data of block 604 and/or the additional object characteristics of block 606. For example, the heating parameters (e.g., position and/or orientation of the heating element relative to the object surface, output of the heating element, activation of the heating element) can be adjusted based on the local surface topography and/or other object characteristics in order to control the extent of surface modification. In some embodiments, the heating element is configured to apply heat to only a specific portion of the object surface (e.g., a spot, line, or area) at a time, and the vertical position of the heating element is adjusted according to the height of the corresponding object portion in order to control the distance between the heating element and the object surface. The distance can be fixed or variable, depending on the desired treatment depth, material composition of the object, intended function of the object, target distribution of surface characteristics, etc.

Alternatively or in combination, the output of the heating element (e.g., intensity, flame size) can be varied according to the height and/or other characteristics of the object portion. For instance, a higher heat intensity and/or larger flame size can be used to treat object portions that have a lower height, a greater thickness, and/or are made out of a material with a higher melting point. Conversely, a lower heat intensity and/or smaller flame size can be used to treat object portions that have a greater height, a lower thickness, and/or are made out of a material with a lower melting point. The adjustments to the output of the heating element can be selected based on the desired treatment depth, material composition of the object, intended function of the object, target distribution of surface characteristics, etc.

The surface characteristics of the object after the process of block 608 can be varied as desired, depending on the intended use of the object. In some embodiments, for example, the object has at least one surface with an initial Ra of at least 5 μm, 10 μm, 15 μm, or 20 μm; and the process of block 608 is configured to reduce the Ra to no more than 10 μm, 5 μm, 4 μm, 3 μm, 2 μm, or 1 μm. As another example, the object can have at least one surface with an initial porosity of at least 1%, 1.5%, 2%, 2.5%, 3%, 3.5%, 4% 4.5%, or 5%; and the process of block 608 is configured to reduce the porosity to no more than 1%, 0.75%, 0.5%, 0.25%, 0.1%, or 0.05%.

In some embodiments, the surface characteristics of the object are substantially uniform (e.g., no more than 10% variation). In other embodiments, however, some portions of the object can have different characteristics (e.g., different roughness, porosity, treatment depth) than other portions of the object, depending on the heating parameters used. For example, the object can include two, three, four, five, six, seven, eight, nine, ten, or more object portions having different surface characteristics. The distribution of surface characteristics can be selected based on the function of each object portion (e.g., whether the portion will be contacting the patient's teeth, gingiva, palate, and/or tongue; whether the portion will be visible when worn); the material composition of each object portion; and/or any other suitable considerations.

The method 600 can be modified in many different ways. For example, although the above steps of the method 600 are described with respect to a single object, the method 600 can be used to sequentially or concurrently process any suitable number of objects, such as tens, hundreds, or thousands of additively manufactured objects. In some embodiments, the objects are associated with a single individual (e.g., a series of dental appliances used to treat a single patient), while in other embodiments, the objects can be associated with multiple individuals (e.g., a batch of dental appliances for a plurality of patients). As another example, the ordering of the processes shown in FIG. 6 can be varied. Some of the processes of the method 600 can be omitted, such as the process of block 606. The method 600 can also include additional processes not shown in FIG. 6. For instance, the heating applied in block 608 can be configured to achieve other functions, such as burning and/or removal of sacrificial material (e.g., supports) that are not intended to be in the final product.

FIG. 7A is a partially schematic diagram of a system 700a for processing an additively manufactured object 702, in accordance with embodiments of the present technology. The system 700a can be used to implement any of the methods described herein, such as the method 600 of FIG. 6. Additionally, the system 700a can be used in combination with any of the other systems and devices described herein. For example, the system 700a can be part of the surface modification subsystem 308 of FIG. 3.

The object 702 can be received from an additive manufacturing system (not shown) and positioned on a conveyer belt 704 or other suitable mechanism configured to transport the object 702 through the various sections of the system 700a. The object 702 can be placed on the conveyer belt 704 in a random position and/or orientation, or can be placed in a predetermined position and/or orientation. Optionally, the object 702 can be positioned on a substrate (e.g., carrier, tray, build platform) that is placed on the conveyer belt 704.

The conveyer belt 704 can first transport the object 702 to a sensing zone 706 adjacent or near at least one sensor 708. The sensor 708 can be configured to generate topography data of the object 702, as previously described with respect to block 604 of the method 600 of FIG. 6. For example, the sensor 708 can be configured to measure the height of the surface of the object 702 at one or more locations (e.g., at a plurality of discrete points, along a line, over a region). The height can be measured relative to a reference location on the object 702, relative to the surface of the conveyer belt 704, and/or relative to the surface of a substrate supporting the object 702 on the conveyer belt 704. Optionally, the height can be determined by measuring the distance between the object 702 and the sensor 708.

The sensor 708 can include an imaging device, distance sensor, or any other sensor type suitable for measuring the 3D topography of the surface of the object 702. Although the embodiment of FIG. 7A includes a single sensor 708, in other embodiments, the system 700a can include multiple sensors 708, such as two, three, four, five, 10, 20, or more sensors 708. In embodiments where multiple sensors 708 are used, some or all of the sensors 708 can be different sensor types, and/or some or all of the sensors 708 can be positioned at different locations relative to the object 702.

Subsequently, the conveyer belt 704 can transport the object 702 to a treatment zone 710 adjacent or near a heating element 712. The heating element 712 can be configured to apply heat to the object 702 in order to modify the surface characteristics of the object 702, in accordance with the techniques described above with respect to the method 600 of FIG. 6. For example, as shown in FIG. 7A, the heating element 712 is configured as a multi-stage flame generator that outputs a plurality of flames 714a-714d (collectively, “flames 714”). Although FIG. 7A illustrates four flames 714, in other embodiments, however the heating element 712 can output a different number of flames 714, such as two, three, five, six, seven, eight, nine, ten, or more flames 714.

The flames 714 can be horizontally spaced apart from each such that each flame applies heat to a different portion of the surface of the object 702. In the illustrated embodiment, for example, the first flame 714a is configured to heat a first surface portion 716a of the object 702, the second flame 714b and third flame 714c are configured to heat a second surface portion 716b of the object 702, and the fourth flame 714d is configured to heat a third surface portion 716c of the object 702. The horizontal distance between the first flame 714a and the last flame 714d can be the same or similar as (e.g., within 10%) of the length of the object 702, such that the entire length of the object 702 can be heated without moving the heating element 712 and/or object 702 horizontally (e.g., along the direction of motion of the conveyer belt 704). Alternatively, the horizontal distance between the first flame 714a and the last flame 714d can be less than the length of the object 702. In such embodiments, the surface of the object 702 can be heated sequentially by moving the object 702 horizontally relative to the heating element 712 via the conveyer belt 704 and/or by moving the heating element 712 horizontally relative to the object 702.

The operating parameters of each flame 714 (e.g., activation, intensity, direction, size) can be independently controllable. For example, each flame 714 can be independently turned on and off. As another example, the intensity of each flame 714 can also be independently adjusted to provide the desired degree of heating, as discussed in greater detail below. In the illustrated embodiment, the flames 714 are each oriented in a vertical direction toward the surface of the object 702. In other embodiments, some or all of the flames 714 can be oriented differently. Additionally, the direction of each flame 714 can be fixed, or can be variable.

The flame height, flame width (e.g., measured orthogonal to the direction of motion of the conveyer belt 704), and/or flame depth (e.g., measured along the direction of motion of the conveyer belt 704) can also be independently controlled for each flame 714. In some embodiments, some or all of the flames 714 have a width that is the same or similar as (e.g., within 10%) the width of the object 702 and/or conveyer belt 704, such that the entire width of the object 702 can be heated without moving the object 702 and/or heating element 712 laterally (e.g., in a direction orthogonal to the direction of motion of the conveyer belt 704). Alternatively, some or all of the flames 714 can have a width that is less than the width of the object 702. In such embodiments, the flames 714 can be arranged in a 2D array and/or the heating element 712 can be movable along a lateral direction so as to provide heating along the entire width of the object 702.

The heating applied by the heating element 712 can be adjusted based on the topography data produced by the sensor 708, as previously described with respect to the method 600 of FIG. 6. For example, the operating parameters of each flame 714 can be controlled based on the topography data so as to provide substantially uniform heating of the object surface. In some embodiments, the flame height is adjusted according to the height of the corresponding portion of the object surface so that each portion receives the same or a similar degree of heating. The height of each flame 714 can be selected so that the tip of each flame 714 contacts or comes in close proximity to the corresponding surface portion of the object 702, e.g., a longer flame height is used for lower surface portions, and a shorter flame height is used for higher surface portions. In the illustrated embodiment, for example, the object 702 includes a plurality of surface portions having different heights, e.g., the first surface portion 716a has a first surface height, the second surface portion 716b has a second surface height greater than the first surface height, and the third surface portion 716c has the first surface height. Accordingly, the first flame 714a can have a first flame height, the second flame 714b and third flame 714c can have a second flame height less than the first flame height, and the fourth flame 714d can have the first flame height. In other embodiments, however, the operating parameters of each flame 714 can be configured to apply non-uniform heating of the object surface, e.g., if the object 702 includes different material types, if non-uniform surface modifications are desired, etc.

The system 700a can include a controller 718 configured to monitor and control the various operations described herein, e.g., via one or more control signals. The controller 718 can be or include a computing device including one or more processors and memory storing instructions for controlling the operations of the system 700a. For example, the controller 718 can be operably coupled to the conveyer belt 704 to control the movement speed and/or movement direction of the conveyer belt 704. The controller 718 can also be operably coupled to the sensor 708 to transmit instructions to the sensor 708 (e.g., instructions for obtaining topography data of the object 702) and to receive topography data generated by the sensor 708. The controller 718 can also be operably coupled to the heating element 712 to control the operating parameters of the flames 714, e.g., based on the topography data from the sensor 708 and/or data of additional characteristics of the object 702, as described elsewhere herein.

In the illustrated embodiment, the object 702 is placed on the conveyer belt 704 such that a single surface of the object 702 (e.g., the upper surface) is oriented toward and exposed to the sensor 708 and the heating element 712. Accordingly, a single surface of the object 702 can be processed in a single cycle through the system 700a. To process the other surfaces of the object 702 (e.g., the bottom surface and/or lateral surfaces), the system 700a can include a device configured to flip or otherwise change the orientation of the object 702, such as a flipper, robotic arm, etc. The device can be located after the treatment zone 710 so as to receive and reorient each object 702 after heating. The flipped object 702 can then be returned to the beginning of the conveyer belt 704 to process the newly exposed surface(s). This sequence can be repeated until all desired surfaces have been treated.

In other embodiments, the system 700a can include devices in the sensing zone 706 and/or treatment zone 710 that are configured to reorient the object 702 to expose multiple surfaces for sensing and/or heating, respectively. Alternatively or in combination, the sensor 708 and/or heating element 712 can be moved relative to the object 702 to sense and/or heat multiple surfaces, respectively. Optionally, the sensor 708 and/or heating element 712 can be respectively configured to sense and/or heat multiple surfaces of the object 702, without requiring movement of the object 702, sensor 708, and/or heating element 712. These techniques can be used to process multiple surfaces of the object 702 in a single cycle through the system 700a.

The system 700a of FIG. 7A can be modified in many ways. For example, although the system 700a of FIG. 7A is illustrated and described with respect to a single object 702, the system 700a can be used to sequentially or concurrently process any suitable number of objects 702, such as tens, hundreds, or thousands of objects 702. As another example, the system 700a can include additional components not shown in FIG. 7A, such as additional sensors for monitoring and/or feedback at other portions of the system 700a (e.g., within or after the treatment zone 710).

FIG. 7B is a partially schematic diagram of another system 700b for processing an object 702, in accordance with embodiments of the present technology. The system 700b can be generally similar to the system 700a of FIG. 7A, except that the treatment zone 710 includes a movable heating element 720 configured to output a flame 722. The movable heating element 720 can be coupled to an actuatable device (e.g., a robotic arm, gimbal, linear and/or rotary actuator) that allows the movable heating element 720 to be moved to a plurality of different poses (e.g., positions and/or orientations) relative to the object 702. The adjustments to the movable heating element 720 can be made based on the topography data obtained by the sensor 708 and/or data of additional object characteristics, as previously described.

In the illustrated embodiment, for example, the movable heating element 720 is translatable in a vertical direction so that the distance between the flame 722 and the object 702 can be adjusted as the object 702 is advanced past the flame 722 by the conveyer belt 704. The height of the movable heating element 720 can be adjusted according to the height of the currently heated portion of the object surface so that each portion receives the same or a similar degree of heating. Specifically, the height of the movable heating element 720 can be controlled so that the tip of the flame 722 contacts or comes in close proximity to the corresponding surface portion of the object 702, e.g., the movable heating element 720 is moved lower for lower surface portions, and is moved higher for higher surface portions. In the illustrated embodiment, for example, the movable heating element 720 can be moved to a first height when treating the first surface portion 716a and the third surface portion 716c, and can be moved to a second, higher height when treating the second surface portion 716b. In other embodiments, however, the height of the movable heating element 720 can be adjusted to apply non-uniform heating of the object surface, e.g., if the object 702 includes different material types, if non-uniform surface modifications are desired, etc. Additionally, the flame 722 can be maintained at a fixed size and/or intensity while the movable heating element 720 is adjusted, or the size and/or intensity of the flame 722 can be varied together with the adjustments to the movable heating element 720.

Optionally, the movable heating element 720 can be moved in other directions to heat other surfaces of the object 702, such as laterally, horizontally, rotationally, etc. Moreover, although the system 700b is illustrated as including a single movable heating element 720 configured to output a single flame 722, in other embodiments, the system 700b can include any suitable number of movable heating elements 720 (e.g., two, three, four, five, or more movable heating elements 720), each of which can output any suitable number of flames 722 (e.g., one, two, three, four, five, or more flames 722).

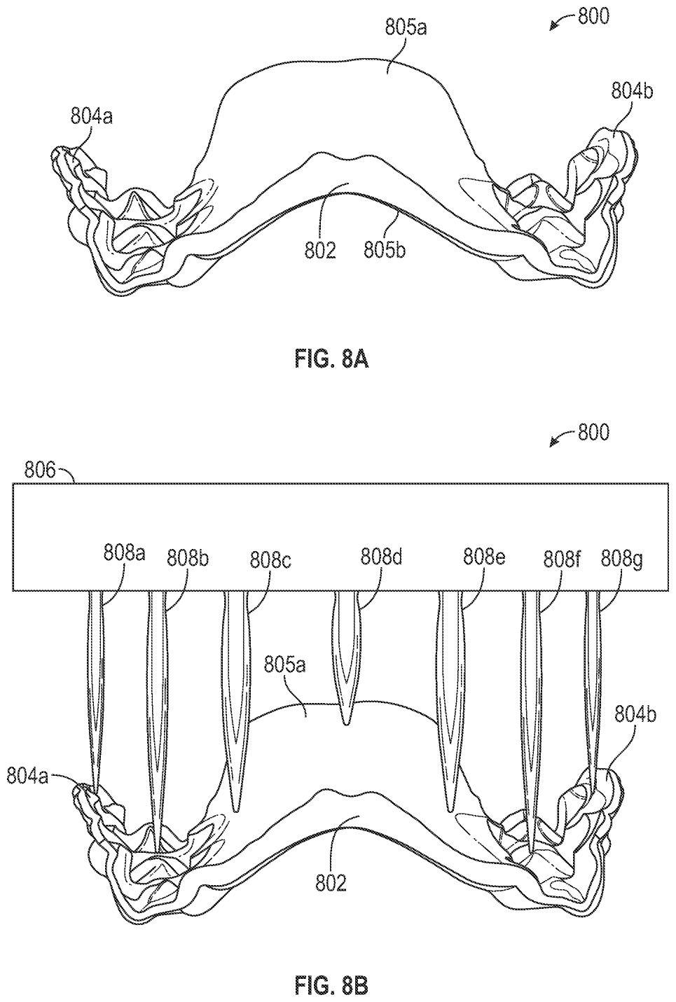

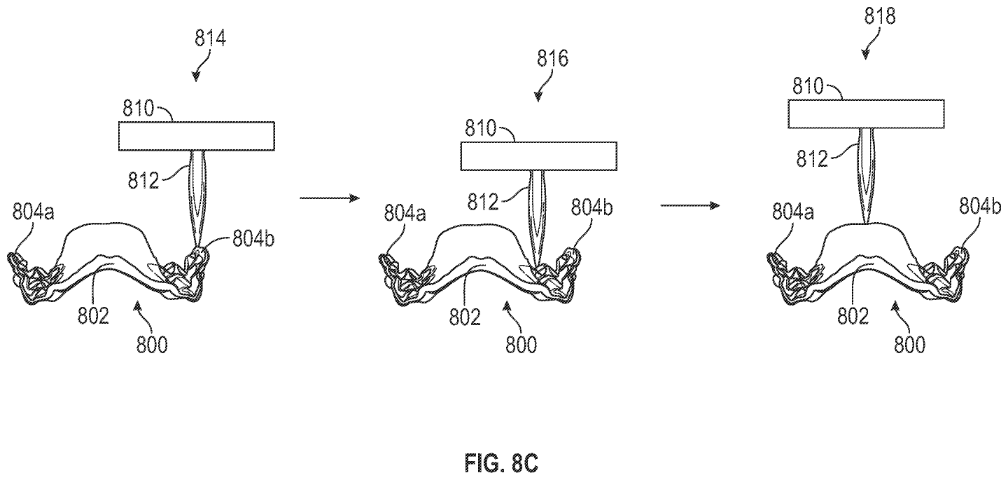

FIG. 8A is a perspective view of a palatal expander 800 configured in accordance with embodiments of the present technology. The palatal expander 800 (also referred to herein as a “palate expander” or an “arch expander”) can be fabricated and processed using the techniques described herein. For example, the palatal expander 800 can be fabricated from a biocompatible material (e.g., nylon) via additive manufacturing. The palatal expander 800 includes an expander portion 802 configured to be positioned near a patient's palate, and a pair of teeth engaging portions 804a, 804b coupled to opposite sides of the expander portion 802. Each teeth engaging portion 804a, 804b can include a plurality of teeth-receiving cavities. For example, the teeth engaging portions 804a, 804b can be configured to receive the three posterior teeth on each side of the patient's mouth.

The expander portion 802 can have an arched shape similar to the shape of the patient's palate, and can include an upper surface 805a and a lower surface 805b opposite the upper surface 805a. The height of the expander portion 802 can be configured so that, when the palatal expander 800 is worn, there is a gap between the upper surface 805a of the expander portion 802 and the patient's palate. Alternatively, the upper surface 805a of the expander portion 802 can be configured to contact the palate when worn.

In some embodiments, the upper surface 805a of the expander portion 802 matches the topography of the patient's palate, e.g., including any grooves, ridges, troughs, etc., that are present in the patient's particular anatomy. The lower surface 805b of the expander portion 802, which faces the patient's tongue, can have a different surface topography compared to the upper surface. For example, the lower surface 805b can be smoother than the upper surface 805a for improved comfort and/or to avoid interfering with speech. In some embodiments, the lower surface 805b lacks the grooves, ridges, troughs, etc., present on the upper surface 805a, and/or can be substantially free from perceptible projections, lumps, and/or indentations.

During use, the expander portion 802 can apply forces against teeth at the opposite sides of the patient's mouth to cause the patient's palate to expand. Specifically, the engagement between the expander portion 802 and the teeth engaging portions 804a, 804b can apply a force against the received teeth that increases the size of the palate when worn by the patient. In some embodiments, the expander portion 802 has different properties than the teeth engaging portions 804a, 804b in order to apply sufficient forces to widen the palate. For example, the expander portion 802 can have a higher T_{g} and/or greater thickness than the teeth engaging portions 804a, 804b.

A series of palatal expanders 800 can be used and incrementally staged to expand a patient's palate, e.g., by progressively increasing the width of the expander portion 802 according to the desired palatal width for the corresponding treatment stage. For example, a series of palatal expanders 800 can expand a patient's palate from an initial arrangement (e.g., an initial width) to a target arrangement (e.g., a target width), with each palatal expander 800 being used to incrementally expand the palate from a respective first arrangement (e.g., a first palatal width) toward a respective second arrangement (e.g., a second palatal width). During use, each palatal expander 800 can be worn for a period of time, then replaced with the next expander in the series. This process can be repeated until the desired palatal expansion has been achieved. Optionally, the series of palatal expanders 800 can include a passive holder (e.g., a retainer) that is configured to maintain the patient's palate at a desired width, e.g., after the completion of treatment. Additional details of palatal expanders suitable for use with the present technology are described in U.S. Pat. Nos. 10,959,810 and 11,273,011, the disclosures of each of which are incorporated herein by reference in their entirety.

FIG. 8B illustrates surface modification of the palatal expander 800 using a heating element 806, in accordance with embodiments of the present technology. The heating element 806 can be implemented as part of any of the systems and devices described herein, such as the system 700a of FIG. 7A, and can be generally similar to the heating element 712 of FIG. 7A.

The heating element 806 is configured to output a plurality of flames 808a-808g (collectively, “flames 808”). Although FIG. 8B illustrates seven flames 808, in other embodiments, the heating element 806 can produce a different number of flames 808 (e.g., one, two, three, four, five, six, eight, nine, ten, or more flames 808). Each flame 808 is configured to heat a different portion of the upper surface 805a of the palatal expander 800. For example, flames 808a and 808b are configured to heat the teeth engaging portion 804a, flames 808c— 808e are configured to heat the expander portion 802, and flames 808f and 808g are configured to heat the teeth engaging portions 804b.

The parameters of each flame 808 can be adjusted to produce a desired extent of heating of the corresponding portion of the palatal expander 800. For example, as shown in FIG. 8B, the height of each flame 808 can be varied according to the height of the corresponding portion of the palatal expander 800 (e.g., flames 808b and 808f are heating the lowest portions of the palatal expander 800 and therefore have the longest flame height; flame 808d is heating the highest portion of the palatal expander 800 and therefore has the shortest flame height; flames 808a, 808c, 808e, and 808g are heating intermediate portions of the palatal expander 800 and therefore have intermediate heights). This approach can be used to produce a substantially uniform treatment depth of the surface 805a of the palatal expander 800.

Additionally, the intensity of each flame 808 can be adjusted based on the thickness of the corresponding portion of the palatal expander 800 (e.g., flames 808c-808e are heating the thicker expander portion 802 and therefore have higher intensities; flames 808a, 808b, 808f, and 808g are heating the thinner teeth engaging portions 804a, 804b and therefore have lower intensities). This approach can reduce adverse effects on the mechanical integrity of the palatal expander 800 due to excessive softening and/or melting.

FIG. 8C illustrates surface modification of the palatal expander 800 using a movable heating element 810, in accordance with embodiments of the present technology. The movable heating element 810 can be implemented as part of any of the systems and devices described herein, such as the system 700b of FIG. 7B, and can be generally similar to the movable heating element 720 of FIG. 7B.

The movable heating element 810 is configured to output at least one flame 812. The palatal expander 800 can be advanced horizontally past the movable heating element 810 so that the flame 812 sequentially heats different portions of the palatal expander 800. Although FIG. 8C illustrates a single flame 812, in other embodiments, the movable heating element 810 can produce a different number of flames 812 (e.g., two, three, four, five, six, eight, nine, ten, or more flames 812).

The vertical height of the movable heating element 810 can be adjusted based on the height of the currently heated portion of the palatal expander 800. For example, as shown in FIG. 8C, during a first stage 814, the flame 812 is heating a portion of the palatal expander 800 having an intermediate height (e.g., the buccal side of the teeth engaging portion 804b), and the movable heating element 810 is at a first vertical position. During a second stage 816, the flame 812 is heating a portion of the palatal expander 800 having a lower height (the lingual side of the teeth engaging portion 804b), and the movable heating element 810 is at a second vertical position that is lower than the first vertical position. During a third stage 818, the flame 812 is heating a portion of the palatal expander 800 having a higher height (e.g., the expander portion 802), and the movable heating element 810 is at a third vertical position that is higher than the first and second vertical positions.

Optionally, the parameters of the flame 812 can also be varied. For instance, during the first stage 814 and second stage 816, the flame 812 can have a lower intensity to avoid excessive heating of the relative thin teeth engaging portion 804b. During the third stage 818, the flame 812 can have a higher intensity to ensure sufficient heating of the relatively thick expander portion 802.

### III. Dental Appliances and Associated Methods

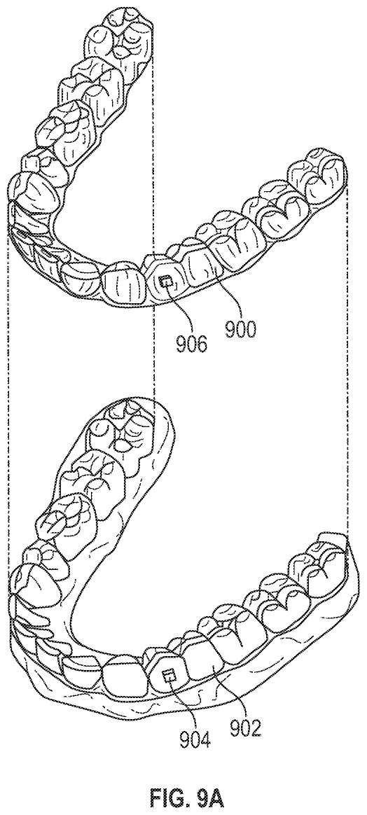

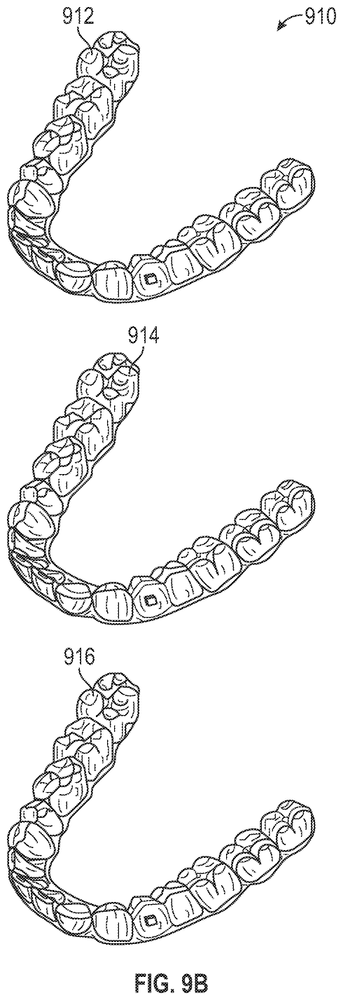

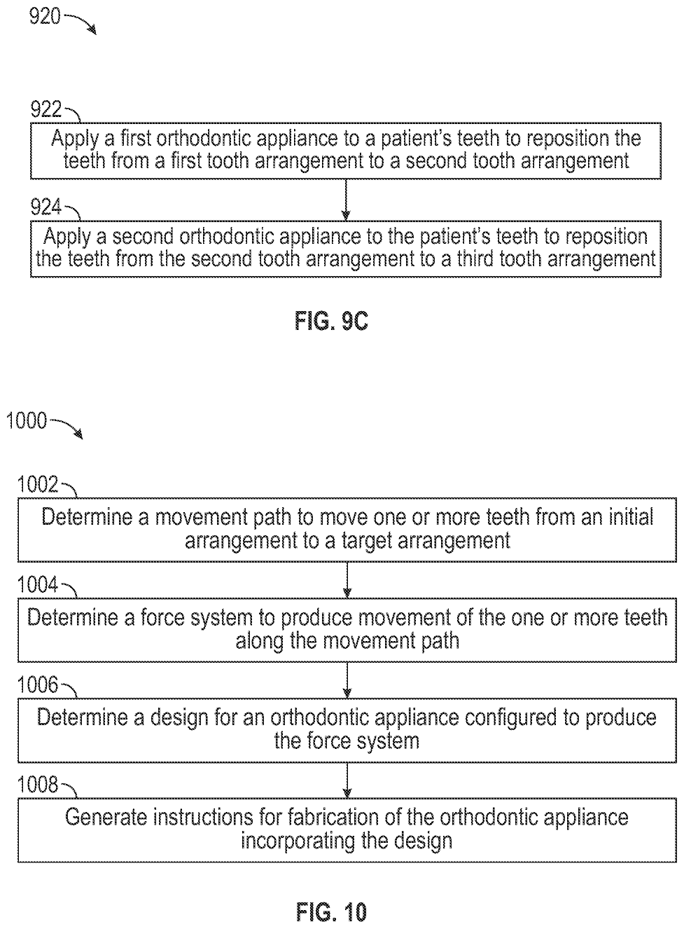

FIG. 9A illustrates a representative example of a tooth repositioning appliance 900 configured in accordance with embodiments of the present technology. The appliance 900 can be manufactured and post-processed using any of the systems, methods, and devices described herein. The appliance 900 (also referred to herein as an “aligner”) can be worn by a patient in order to achieve an incremental repositioning of individual teeth 902 in the jaw. The appliance 900 can include a shell (e.g., a continuous polymeric shell or a segmented shell) having teeth-receiving cavities that receive and resiliently reposition the teeth. The appliance 900 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 900 can fit over all teeth present in an upper or lower jaw, or less than all of the teeth. The appliance 900 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 900 can be a generic appliance configured to receive the teeth, but not necessarily shaped to match the topography of the patient's teeth. In some cases, only certain teeth received by the appliance 900 are repositioned by the appliance 900 while other teeth can provide a base or anchor region for holding the appliance 900 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 900 in place over the teeth. In some cases, however, it may be desirable or necessary to provide individual attachments 904 or other anchoring elements on teeth 902 with corresponding receptacles 906 or apertures in the appliance 900 so that the appliance 900 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 9B illustrates a tooth repositioning system 910 including a plurality of appliances 912, 914, 916, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 910 can include a first appliance 912 corresponding to an initial tooth arrangement, one or more intermediate appliances 914 corresponding to one or more intermediate arrangements, and a final appliance 916 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 9C illustrates a method 920 of orthodontic treatment using a plurality of appliances, in accordance with embodiments of the present technology. The method 920 can be practiced using any of the appliances or appliance sets described herein. In block 922, a first orthodontic appliance is applied to a patient's teeth in order to reposition the teeth from a first tooth arrangement to a second tooth arrangement. In block 924, a second orthodontic appliance is applied to the patient's teeth in order to reposition the teeth from the second tooth arrangement to a third tooth arrangement. The method 920 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

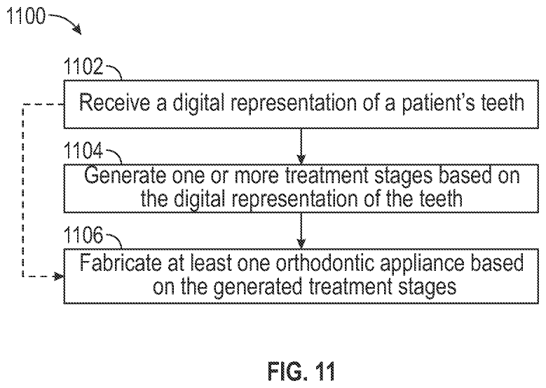

FIG. 10 illustrates a method 1000 for designing an orthodontic appliance, in accordance with embodiments of the present technology. The method 1000 can be applied to any embodiment of the orthodontic appliances described herein. Some or all of the steps of the method 1000 can be performed by any suitable data processing system or device, e.g., one or more processors configured with suitable instructions.

In block 1002, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1004, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1004 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1006, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1008, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1000 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1000 may be performed with any suitable fabrication system or device, such as the embodiments described herein. Some of the steps may be optional, e.g., the process of block 1004 can be omitted, such that the orthodontic appliance is designed based on the desired tooth movements and/or determined tooth movement path, rather than based on a force system. Moreover, the order of the steps can be varied as desired.

FIG. 11 illustrates a method 1100 for digitally planning an orthodontic treatment and/or design or fabrication of an appliance, in accordance with embodiments. The method 1100 can be applied to any of the treatment procedures described herein and can be performed by any suitable data processing system.

In block 1102 a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1104, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1106, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 11, design and/or fabrication of an orthodontic appliance, and perhaps a particular orthodontic treatment, may include use of a representation of the patient's teeth (e.g., including receiving a digital representation of the patient's teeth (block 1102)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment placement devices, e.g., appliances used to position pre-fabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled, “Flexible 3D Printed Orthodontic Device,” filed Feb. 24, 2021; U.S. application Ser. No. 16/366,686, entitled, “Dental Attachment Placement Structure,” filed Mar. 27, 2019; U.S. application Ser. No. 15/674,662, entitled, “Devices and Systems for Creation of Attachments,” filed Aug. 11, 2017; U.S. Pat. No. 11,103,330, entitled, “Dental Attachment Placement Structure,” filed Jun. 14, 2017; U.S. application Ser. No. 14/963,527, entitled, “Dental Attachment Placement Structure,” filed Dec. 9, 2015; U.S. application Ser. No. 14/939,246, entitled, “Dental Attachment Placement Structure,” filed Nov. 12, 2015; U.S. application Ser. No. 14/939,252, entitled, “Dental Attachment Formation Structures,” filed Nov. 12, 2015; and U.S. Pat. No. 9,700,385, entitled, “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled, “Releasable Palatal Expanders,” filed Apr. 10, 2019; U.S. application Ser. No. 16/022,552, entitled, “Devices, Systems, and Methods for Dental Arch Expansion,” filed Jun. 28, 2018; U.S. Pat. No. 11,045,283, entitled, “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled, “Methods and Apparatuses for Customizing a Rapid Palatal Expander,” filed Dec. 4, 2017; and U.S. Pat. No. 7,192,273, entitled, “System and Method for Palatal Expansion,” filed Aug. 7, 2003; all of which are incorporated by reference herein in their entirety.

### Examples

The following examples are included to further describe some aspects of the present technology, and should not be used to limit the scope of the technology.
Example 1. A system comprising:
a controller configured to provide one or more control signals;
a heater coupled to the controller, wherein the heater comprises one or more heating elements arranged to heat a blasting medium in response to the one or more control signals;
a chamber coupled to the controller, wherein the chamber comprises an agitatable drum shaped to receive a plurality of additively manufactured objects, and to agitate the plurality of additively manufactured objects in response to the one or more control signals; and
an applicator coupled to the controller, wherein the applicator comprises a nozzle operative to direct, in response to the one or more control signals, a plurality of thermally conductive particles in the blasting medium toward the plurality of additively manufactured objects within the agitatable drum.
Example 2. The system of Example 1, further comprising a medium source coupled to the heater, wherein the medium source is arranged to hold the blasting medium.
Example 3. The system of Example 1 or 2, wherein the agitatable drum comprises a rotating drum, a translating drum, or a combination thereof.
Example 4. The system of any one of Examples 1 to 3, wherein the blasting medium comprises metal particles, ceramic particles, or a combination thereof.
Example 5. The system of any one of Examples 1 to 4, wherein the agitatable drum comprises an inner portion shaped to allow removal of excess thermally conductive particles of the plurality of thermally conductive particles.
Example 6. The system of Example 5, wherein the inner portion comprises perforations to allow removal of the excess thermally conductive particles.
Example 7. The system of any one of Examples 1 to 6, wherein the agitatable drum comprises an outer portion to catch excess thermally conductive particles of the plurality of thermally conductive particles.
Example 8. The system of Example 7, wherein the outer portion does not have perforations.
Example 9. The system of any one of Examples 1 to 8, further comprising a sensor coupled to the controller, wherein the sensor is operative to sense if the agitatable drum has an excess mechanical load.
Example 10. The system of Example 9, wherein the excess mechanical load comprises an excessive torque, an excessive force, or a combination thereof.
Example 11. The system of Example 9 or 10, wherein, in response to a determination that the agitatable drum has an excess mechanical load, the controller is operative to shut the agitatable drum off, slow the agitatable drum down, or a combination thereof.
Example 12. The system of any one of Examples 9 to 11, wherein the excess mechanical load is due to at least a portion of the thermally conductive particles not exiting perforations in an inner portion of the agitatable drum.
Example 13. The system of any one of Examples 1 to 12, wherein the plurality of additively manufactured objects comprises an additively manufactured palatal expander to expand a person's palate from a first arrangement toward a second arrangement.
Example 14. The system of any one of Examples 1 to 13, wherein the plurality of additively manufactured objects comprises a series of incremental palatal expanders to expand a person's palate from a first arrangement toward a second arrangement.
Example 15. The system of any one of Examples 1 to 14, wherein the plurality of additively manufactured objects comprises a series of incremental palatal expanders to expand a person's palate from an initial arrangement toward a target arrangement.
Example 16. The system of any one of Examples 1 to 15, wherein the plurality of additively manufactured objects comprises a batch of incremental palatal expanders to expand one or more persons' palates.
Example 17. The system of any one of Examples 1 to 16, the plurality of additively manufactured objects comprises a batch of incremental palatal expanders to expand palates of a plurality of people.
Example 18. The system of any one of Examples 1 to 16, wherein:
the plurality of additively manufactured objects comprises a series of incremental palatal expanders to expand a person's palate from an initial arrangement toward a target arrangement in accordance with a treatment plan; and
the series of incremental palatal expanders are associated with a single person.
Example 19. The system of any one of Examples 1 to 18, wherein the plurality of additively manufactured objects are composed of a thermoplastic material.
Example 20. A system comprising:
a controller configured to provide one or more control signals;
a heater coupled to the controller, wherein the heater comprises one or more heating elements arranged to heat a blasting medium in response to the one or more control signals;
a chamber coupled to the controller, wherein the chamber comprises an agitatable drum shaped to receive a plurality of additively manufactured objects, and to agitate the plurality of additively manufactured objects in response to the one or more control signals; and
an applicator coupled to the controller, wherein the applicator comprises a means for directing, in response to the one or more control signals, a plurality of thermally conductive particles in the blasting medium toward the plurality of additively manufactured objects within the agitatable drum.
Example 21. A method comprising:
receiving a dental appliance fabricated from a thermoplastic material using an additive manufacturing process;
modifying a surface of the dental appliance via mechanical deformation by applying a blasting medium to the surface of the object, wherein the blasting medium comprises a plurality of thermally conductive particles that are heated to an elevated temperature; and
collecting the blasting medium for reuse.
Example 22. The method of Example 21, wherein modifying the surface of the dental appliance comprises decreasing a roughness of the surface of the dental appliance, decreasing a porosity of the surface of the dental appliance, or a combination thereof.
Example 23. The method of Example 21 or 22, wherein the mechanical deformation comprises plastic deformation.
Example 24. The method of any one of Examples 21 to 23, wherein the thermoplastic material has a glass transition temperature, and the elevated temperature is greater than or equal to the glass transition temperature.
Example 25. The method of any one of Examples 21 to 24, wherein the elevated temperature is within a range from 50° C. to 200° C.
Example 26. The method of any one of Examples 21 to 25, wherein the plurality of thermally conductive particles are made out of a metal, a ceramic, or a combination thereof.
Example 27. The method of any one of Examples 21 to 26, wherein the plurality of thermally conductive particles have an average diameter within a range from 50 μm to 2 mm.
Example 28. The method of any one of Examples 21 to 27, wherein the elevated temperature is a first elevated temperature, and the method further comprises adjusting an environmental temperature to a second elevated temperature while applying the blasting medium to the surface of the dental appliance.
Example 29. The method of Example 28, wherein the second elevated temperature is within a range from 30° C. to 100° C.
Example 30. The method of any one of Examples 21 to 29, wherein the additive manufacturing process comprises selective laser sintering.
Example 31. The method of any one of Examples 21 to 30, wherein the dental appliance is a palatal expander.
Example 32. A system for processing additively manufactured objects, the system comprising:
a chamber configured to receive a dental appliance fabricated from a thermoplastic material using an additive manufacturing process;
an applicator configured to direct a blasting medium toward the object within the chamber to cause mechanical deformation of a surface of the object, wherein the blasting medium comprises a plurality of thermally conductive particles;
a first heating element configured to heat the blasting medium to a first elevated temperature; and
a second heating element configured to heat the chamber to a second elevated temperature.
Example 33. The system of Example 32, wherein the mechanical deformation causes a decrease in a roughness of the surface of the dental appliance, a decrease in a porosity of the surface of the dental appliance, or a combination thereof.
Example 34. The system of Example 32 or 33, wherein the thermoplastic material has a glass transition temperature, and the first elevated temperature is greater than or equal to the glass transition temperature.
Example 35. The system of any one of Examples 32 to 34, wherein the first elevated temperature is within a range from 50° C. to 200° C.
Example 36. The system of any one of Examples 32 to 35, wherein the plurality of thermally conductive particles are made out of a metal, a ceramic, or a combination thereof.
Example 37. The system of any one of Examples 32 to 36, wherein the plurality of thermally conductive particles have an average diameter within a range from 50 μm to 2 mm.
Example 38. The system of any one of Examples 32 to 37, wherein the second elevated temperature is within a range from 30° C. to 100° C.
Example 39. The system of any one of Examples 32 to 38, further comprising:
a tumbler configured to hold the object, and
an actuator configured to rotate the tumbler while the applicator directs the blasting medium toward the object.
Example 40. The system of any one of Examples 32 to 39, further comprising a container configured to collect the blasting medium for reuse.
Example 41. A method comprising:
receiving an object fabricated using an additive manufacturing process;
modifying a surface of the object via mechanical deformation by applying a blasting medium to the surface of the object, wherein the blasting medium is heated to an elevated temperature; and
collecting the blasting medium for reuse.
Example 42. The method of Example 41, wherein the additive manufacturing process comprises selective laser sintering.
Example 43. The method of Example 41 or 42, wherein the object is fabricated from a biocompatible material.
Example 44. The method of any one of Examples 41 to 43, wherein modifying the surface of the object comprises decreasing a roughness of the surface of the object.
Example 45. The method of any one of Examples 41 to 44, wherein modifying the surface of the object comprises decreasing a porosity of the surface of the object.
Example 46. The method of any one of Examples 41 to 45, wherein the mechanical deformation comprises plastic deformation.
Example 47. The method of any one of Examples 41 to 46, wherein the object is fabricated from a thermoplastic material.
Example 48. The method of Example 47, wherein the thermoplastic material comprises a glass transition temperature, and the elevated temperature is greater than or equal to the glass transition temperature.
Example 49. The method of Example 47 or 48, further comprising selecting the elevated temperature based on the thermoplastic material.
Example 50. The method of any one of Examples 41 to 49, wherein the elevated temperature is within a range from 50° C. to 200° C.
Example 51. The method of any one of Examples 41 to 50, wherein the blasting medium comprises a thermally conductive material.
Example 52. The method of Example 51, wherein the thermally conductive material comprises a metal, a ceramic, or a combination thereof.
Example 53. The method of Example 51 or 52, wherein the thermally conductive material comprises a metal, and the method further comprises heating the blasting medium to the elevated temperature via induction.
Example 54. The method of any one of Examples 41 to 53, wherein the blasting medium comprises a plurality of particles.
Example 55. The method of Example 54, wherein the plurality of particles have an average diameter within a range from 50 μm to 2 mm.
Example 56. The method of any one of Examples 41 to 55, wherein the elevated temperature is a first elevated temperature, and the method further comprises adjusting an environmental temperature to a second elevated temperature while applying the blasting medium to the surface of the object.
Example 57. The method of Example 56, wherein the second elevated temperature is lower than the first elevated temperature.
Example 58. The method of Example 56 or 57, wherein the second elevated temperature is within a range from 30° C. to 100° C.
Example 59. The method of any one of Examples 41 to 58, further comprising rotating the object while applying the blasting medium.
Example 60. The method of any one of Examples 41 to 59, wherein the object is an orthodontic appliance.
Example 61. The method of Example 60, wherein the orthodontic appliance is a palatal expander.
Example 62. A system for processing additively manufactured objects, the system comprising:
a chamber configured to receive an object fabricated using an additive manufacturing process;
an applicator configured to direct a blasting medium toward the object within the chamber so as to cause mechanical deformation of a surface of the object, wherein the blasting medium is heated to a first elevated temperature;
a first heating element configured to heat the blasting medium to the first elevated temperature; and
a second heating element configured to heat the chamber to a second elevated temperature.
Example 63. The system of Example 62, wherein the mechanical deformation is configured to decrease a roughness of the surface of the object.
Example 64. The system of Example 62 or 63, wherein the mechanical deformation is configured to decrease a porosity of the surface of the object.
Example 65. The system of any one of Examples 62 to 64, wherein the mechanical deformation comprises plastic deformation.
Example 66. The system of any one of Examples 62 to 65, wherein the object is fabricated from a thermoplastic material.
Example 67. The system of Example 66, wherein the thermoplastic material comprises a glass transition temperature, and the first elevated temperature is greater than or equal to the glass transition temperature.
Example 68. The system of any one of Examples 62 to 67, wherein the first elevated temperature is within a range from 50° C. to 200° C.
Example 69. The system of any one of Examples 62 to 68, wherein the blasting medium comprises a thermally conductive material.
Example 70. The system of Example 69, wherein the thermally conductive material comprises a metal, a ceramic, or a combination thereof.
Example 71. The system of Example 69 or 70, wherein the thermally conductive material comprises a metal, and the first heating element is an inductive heater.
Example 72. The system of any one of Examples 62 to 71, wherein the blasting medium comprises a plurality of particles.
Example 73. The system of Example 72, wherein the plurality of particles have an average diameter within a range from 50 μm to 2 mm.
Example 74. The system of any one of Examples 62 to 73, wherein the first heating element comprises one or more of the following: a heated fluid source, an induction heater, a thermoelectric heater, or a heat pump.
Example 75. The system of any one of Examples 62 to 74, wherein the second heating element comprises one or more of the following: a heated fluid source, a thermoelectric heater, or a heat pump.
Example 76. The system of any one of Examples 62 to 75, wherein the second elevated temperature is lower than the first elevated temperature.
Example 77. The system of any one of Examples 62 to 76, wherein the second elevated temperature is within a range from 30° C. to 100° C.
Example 78. The system of any one of Examples 62 to 77, further comprising:
a tumbler configured to hold the object, and
an actuator configured to rotate the tumbler while the applicator directs the blasting medium toward the object.
Example 79. The system of any one of Examples 62 to 78, further comprising a container configured to collect the blasting medium for reuse.
Example 80. The system of any one of Examples 62 to 79, further comprising an additive manufacturing apparatus configured to fabricate the object using the additive manufacturing process.
Example 81. The system of Example 80, wherein the additive manufacturing process comprises selective laser sintering.
Example 82. The system of any one of Examples 62 to 81, wherein the object is an orthodontic appliance.
Example 83. A method comprising:
receiving a dental appliance fabricated from a thermoplastic material using an additive manufacturing process;
obtaining height data of a surface of the dental appliance via at least one sensor; and
modifying the surface of the dental appliance by applying heat to the surface of the dental appliance using at least one heating element, wherein the at least one heating element is adjusted based on the height data.
Example 84. The method of Example 83, wherein modifying the surface of the dental appliance comprises decreasing a roughness of the surface of the dental appliance, decreasing a porosity of the surface of the dental appliance, or a combination thereof.
Example 85. The method of Example 83 or 84, wherein modifying the surface of the dental appliance comprises melting the surface of the dental appliance.
Example 86. The method of Example 85, wherein the surface of the dental appliance is melted to a depth of no more than 50 μm.
Example 87. The method of any one of Examples 83 to 86, wherein adjusting the at least one heating element comprises adjusting one or more of the following: a position of the at least one heating element, an orientation of the at least one heating element, or an intensity of the at least one heating element.
Example 88. The method of any one of Examples 83 to 87, wherein adjusting the at least one heating element comprises adjusting a vertical position of the at least one heating element relative to the dental appliance based on the height data.
Example 89. The method of any one of Examples 83 to 88, wherein the at least one heating element comprises a plurality of heating elements positioned at different locations relative to the dental appliance.
Example 90. The method of any one of Examples 83 to 89, wherein the at least one heating element comprises one or more of the following: a flame generator, a plasma generator, or a corona generator.
Example 91. The method of any one of Examples 83 to 90, wherein the at least one sensor comprises an imaging device or a distance sensor.
Example 92. The method of any one of Examples 83 to 91, further comprising:
identifying a first appliance portion having a first height,
identifying a second appliance portion having a second height different from the first height,
applying heat to the first appliance portion using a set of first heating parameters, and
applying heat to the second appliance portion using a set of second heating parameters.
Example 93. The method of any one of Examples 83 to 92, wherein the dental appliance is a palatal expander.
Example 94. A system for processing additively manufactured objects, the system comprising:
a sensor configured to generate height data;
at least one heating element;
at least one processor; and
a memory operably coupled to the at least one processor and storing instructions that, when executed by the processor, cause the system to perform operations comprising:
   receiving, from the sensor, height data of a surface of a dental appliance fabricated using an additive manufacturing process, and
   applying heat to the surface of the dental appliance via the at least heating element and based on the height data.
Example 95. The system of Example 94, wherein the heat is configured to decrease a roughness of the surface of the dental appliance, decrease a porosity of the surface of the dental appliance, or a combination thereof.
Example 96. The system of Example 94 or 95, wherein the heat is configured to melt the surface of the dental appliance.
Example 97. The method of Example 96, wherein the surface of the dental appliance is melted to a depth of no more than 50 μm.
Example 98. The method of any one of Examples 94 to 97, wherein the at least one heating element comprises one or more of the following: a flame generator, a plasma generator, or a corona generator.
Example 99. The system of any one of Examples 94 to 98, wherein the operations further comprise adjusting the at least one heating element based on the height data.
Example 100. The system of Example 99, wherein adjusting the at least one heating element comprises adjusting one or more of the following: a position of the at least one heating element, an orientation of the at least one heating element, or an intensity of the at least one heating element.
Example 101. The system of any one of Examples 94 to 100, wherein the at least one heating element is movable.
Example 102. The method of any one of Examples 94 to 101, wherein the at least one heating element comprises a plurality of heating elements positioned at different locations relative to the dental appliance.
Example 103. The system of any one of Examples 94 to 102, wherein the sensor comprises an imaging device or a distance sensor.
Example 104. A method, comprising:
receiving an object fabricated using an additive manufacturing process;
obtaining topography data of a surface of the object via at least one sensor;
modifying the surface of the object by applying heat to the surface of the object based on the topography data.
Example 105. The method of Example 104, wherein the additive manufacturing process comprises selective laser sintering.
Example 106. The method of Example 104 or 105, wherein the object is fabricated from a thermoplastic material.
Example 107. The method of any one of Examples 104 to 106, wherein the object is fabricated from a biocompatible material.
Example 108. The method of any one of Examples 104 to 107, wherein modifying the surface of the object comprises melting the surface of the object.
Example 109. The method of Example 108, wherein the surface of the object is melted to a depth of no more than 50 μm.
Example 110. The method of any one of Examples 104 to 109, wherein modifying the surface of the object comprises decreasing a roughness of the surface of the object.
Example 111. The method of any one of Examples 104 to 110, wherein modifying the surface of the object comprises decreasing a porosity of the surface of the object.
Example 112. The method of any one of Examples 104 to 111, wherein the heat is applied to the surface object via at least one heating element.
Example 113. The method of Example 112, further comprising adjusting the at least one heating element based on the topography data.
Example 114. The method of Example 113, wherein adjusting the at least one heating element comprises adjusting one or more of the following: a position of the at least one heating element, an orientation of the at least one heating element, or an intensity of the at least one heating element.
Example 115. The method of Example 113 or 114, wherein the topography data comprises height data, and adjusting the at least one heating element comprises adjusting a vertical position of the at least one heating element relative to the object based on the height data.
Example 116. The method of any one of Examples 112 to 115, wherein the at least one heating element comprises a plurality of heating elements positioned at different locations relative to the object.
Example 117. The method of Example 116, further comprising adjusting an intensity of each of the plurality of heating elements based on the topography data.
Example 118. The method of any one of Examples 104 to 117, wherein the at least one sensor comprises an imaging device or a distance sensor.
Example 119. The method of any one of Examples 104 to 118, further comprising:
identifying a first object portion having a first surface topography,
identifying a second object portion having a second surface topography different from the first surface topography,
applying heat to the first object portion using a set of first heating parameters, and
applying heat to the second object portion using a set of second heating parameters.
Example 120. The method of any one of Examples 104 to 119, further comprising receiving additional data indicative of at least one characteristic of the object, wherein the heat is applied based on the additional data.
Example 121. The method of Example 100, wherein the additional data is indicative of one or more of the following characteristics: a type of the object, a geometry of the object, a type of material used to form the object, a property of the material used to form the object, a location of the material used to form the object, or an initial surface characteristic of the object.
Example 122. The method of Example 120 or 121, further comprising:
receiving an identifier for the object, and
retrieving the additional data from a database using the identifier.
Example 123. The method of any one of Examples 104 to 122, wherein the object is an orthodontic appliance.
Example 124. The method of Example 123, wherein the orthodontic appliance is a palatal expander.
Example 125. A system for processing additively manufactured objects, the system comprising:
a sensor configured to generate topography data;
at least one heating element;
at least one processor; and
a memory operably coupled to the at least one processor and storing instructions that, when executed by the processor, cause the system to perform operations comprising:
   receiving the topography data from the sensor, wherein the topography data characterizes a surface of an object fabricated using an additive manufacturing process, and
   applying heat to the surface of the object via the at least heating element and based on the topography data.
Example 126. The system of Example 125, wherein the heat is configured to melt the surface of the object.
Example 127. The system of Example 126, wherein the surface of the object is melted to a depth of no more than 50 μm.
Example 128. The system of any one of Examples 125 to 127, wherein the heat is configured to decrease a roughness of the surface of the object.
Example 129. The system of any one of Examples 125 to 128, wherein the heat is configured to decrease a porosity of the surface of the object.
Example 130. The system of any one of Examples 125 to 129, wherein the at least one heating element comprises one or more of the following: a flame generator, a plasma generator, or a corona generator.
Example 131. The system of any one of Examples 125 to 130, wherein the operations further comprise adjusting the at least one heating element based on the topography data.
Example 132. The system of Example 131, wherein adjusting the at least one heating element comprises adjusting one or more of the following: a position of the at least one heating element, an orientation of the at least one heating element, or an intensity of the at least one heating element.
Example 133. The system of any one of Examples 125 to 132, wherein the at least one heating element is movable.
Example 134. The system of any one of Examples 125 to 133, wherein the at least one heating element comprises a plurality of heating elements positioned at different locations relative to the object.
Example 135. The system of any one of Examples 125 to 134, wherein the at least one sensor comprises an imaging device.
Example 136. The system of any one of Examples 125 to 135, wherein the at least one sensor comprises a distance sensor.
Example 137. The system of any one of Examples 125 to 136, wherein the operations further comprise:
identifying a first object portion having a first surface topography,
identifying a second object portion having a second surface topography different from the first surface topography,
applying heat to the first object portion using a set of first heating parameters, and
applying heat to the second object portion using a set of second heating parameters.
Example 138. The system of any one of Examples 125 to 137, wherein the operations further comprise receiving additional data indicative of at least one characteristic of the object, wherein the heat is applied based on the additional data.
Example 139. The system of Example 138, wherein the additional data is indicative of one or more of the following characteristics: a type of the object, a geometry of the object, a type of material used to form the object, a property of the material used to form the object, a location of the material used to form the object, or an initial surface characteristic of the object.
Example 140. The system of Example 139, wherein the operations further comprise:
receiving an identifier for the object, and
retrieving the additional data from a database using the identifier.
Example 141. The system of any one of Examples 125 to 140, further comprising an additive manufacturing apparatus configured to fabricate the object using the additive manufacturing process.
Example 142. The system of Example 141, wherein the additive manufacturing process comprises selective laser sintering.
Example 143. The system of any one of Examples 125 to 142, wherein the object is an orthodontic appliance.

### CONCLUSION

Although many of the embodiments are described above with respect to systems, devices, and methods for manufacturing orthodontic appliances, the technology is applicable to other applications and/or other approaches, such as other types of products where improved surface finishes are desirable. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-11.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A system comprising:
a controller configured to provide one or more control signals;
a heater coupled to the controller, wherein the heater comprises one or more heating elements arranged to heat a blasting medium in response to the one or more control signals;
a chamber coupled to the controller, wherein the chamber comprises an agitatable drum shaped to receive a plurality of additively manufactured objects, and to agitate the plurality of additively manufactured objects in response to the one or more control signals; and
an applicator coupled to the controller, wherein the applicator comprises a nozzle operative to direct, in response to the one or more control signals, a plurality of thermally conductive particles in the blasting medium toward the plurality of additively manufactured objects within the agitatable drum.

2. The system of claim 1, further comprising a medium source coupled to the heater, wherein the medium source is arranged to hold the blasting medium.

3. The system of claim 1, wherein the agitatable drum comprises a rotating drum, a translating drum, or a combination thereof.

4. The system of claim 1, wherein the blasting medium comprises metal particles, ceramic particles, or a combination thereof.

5. The system of claim 1, wherein the agitatable drum comprises an inner portion shaped to allow removal of excess thermally conductive particles of the plurality of thermally conductive particles.

6. The system of claim 5, wherein the inner portion comprises perforations to allow removal of the excess thermally conductive particles.

7. The system of claim 1, wherein the agitatable drum comprises an outer portion to catch excess thermally conductive particles of the plurality of thermally conductive particles.

8. The system of claim 7, wherein the outer portion does not have perforations.

9. The system of claim 1, further comprising a sensor coupled to the controller, wherein the sensor is operative to sense if the agitatable drum has an excess mechanical load.

10. The system of claim 9, wherein the excess mechanical load comprises an excessive torque, an excessive force, or a combination thereof.

11. The system of claim 9, wherein, in response to a determination that the agitatable drum has an excess mechanical load, the controller is operative to shut the agitatable drum off, slow the agitatable drum down, or a combination thereof.

12. The system of claim 9, wherein the excess mechanical load is due to at least a portion of the thermally conductive particles not exiting perforations in an inner portion of the agitatable drum.

13. The system of claim 1, wherein the plurality of additively manufactured objects comprises an additively manufactured palatal expander to expand a person's palate from a first arrangement toward a second arrangement.

14. The system of claim 1, wherein the plurality of additively manufactured objects comprises a series of incremental palatal expanders to expand a person's palate from a first arrangement toward a second arrangement.

15. The system of claim 1, wherein the plurality of additively manufactured objects comprises a series of incremental palatal expanders to expand a person's palate from an initial arrangement toward a target arrangement.

16. The system of claim 1, wherein the plurality of additively manufactured objects comprises a batch of incremental palatal expanders to expand one or more persons' palates.

17. The system of claim 1, the plurality of additively manufactured objects comprises a batch of incremental palatal expanders to expand palates of a plurality of people.

18. The system of claim 1, wherein:
the plurality of additively manufactured objects comprises a series of incremental palatal expanders to expand a person's palate from an initial arrangement toward a target arrangement in accordance with a treatment plan; and
the series of incremental palatal expanders are associated with a single person.

19. The system of claim 1, wherein the plurality of additively manufactured objects are composed of a thermoplastic material.

20. A system comprising:
a controller configured to provide one or more control signals;
a heater coupled to the controller, wherein the heater comprises one or more heating elements arranged to heat a blasting medium in response to the one or more control signals;
a chamber coupled to the controller, wherein the chamber comprises an agitatable drum shaped to receive a plurality of additively manufactured objects, and to agitate the plurality of additively manufactured objects in response to the one or more control signals; and
an applicator coupled to the controller, wherein the applicator comprises a means for directing, in response to the one or more control signals, a plurality of thermally conductive particles in the blasting medium toward the plurality of additively manufactured objects within the agitatable drum.
